(19) United States
(12) Patent Application Publication
(10) Pub. No.: US 2009/0277378 A1
(43) Pub. Date: Nov. 12, 2009

(54) COATING APPARATUS

(75) Inventor: Kuniharu Yamauchi, Aichi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ABB K.K., Shibuya-ku (JP)

(21) Appl. No.: 12/374,735

(22) PCT Filed: Oct. 9, 2007
(86) PCT No.: PCT/JP07/70038

§ 371 Date: Jan. 22, 2009

(30) Foreign Application Priority Data
Dec. 27, 2006 (JP) 2006-352144

(51) Int. Cl. B05B 7/04

(52) U.S. Cl. 118/300

(57) ABSTRACT

A round outer periphery of a valve mount member (17) is provided at a rear end portion (3D) of a housing (3) of a main coater body (2), main component valves (22) and wash fluid valve (30) of a main component valve assembly (21) are detachably mounted along with hardener valves (35) and wash fluid valve (36) of a hardener valve assembly (34), a trigger valve (40) and a front end washing valve (43) by means of a clamping mechanism (28). Thus, the respective main component valves (22) and hardener valves (35) are located in positions in the proximity of a rotary atomizing head (5) of the main coater body (2), realizing a significant reduction in length of paint supply passages, permitting to carry out a washing operation in an efficient manner. Besides, the respective main component valves (22) and hardener valves (35) can be detachably mounted on the valve mount member (17) easily by screw members (29) of clamping mechanisms (28), permitting to perform replacement jobs efficiently.

### TECHNICAL FIELD

This invention relates to a coating apparatus suitable for use in coating various work pieces, and more particularly to a coating apparatus suitable for spraying a mixing type paint which is formed by mixing a main component and a hardener with each other on the machine.

### BACKGROUND ART

Generally, as a coating apparatus for use in painting car bodies, furniture and electric appliances, it has been well known in the art to employ a coating apparatus with a paint sprayer means such as a rotary atomizing head or an atomizing nozzle mounted on the front side of a coater body. In this connection, there has been a trend toward using synthetic resin products for various parts on a car body including a bumper, for example. It has been the general practice to paint plastic bumpers by the use of the so-called two component type paint which is formed by mixing a main component with a hardener (a hardening catalyst).

The two component type paint is used by mixing a main component containing a pigment with a hardener which plays a role of hardening the main component. In the case of two component type paint of this sort, the mixing ratio of a hardener to a main component varies depending upon the nature of the main component, and finish quality of coatings is influenced by the accuracy in mixing ratio. Therefore, a coating apparatus is usually arranged to receive supplies of a main component and a hardener through two separate supply lines, i.e., a main component supply line and a hardener supply line which are adapted to deliver a main component and a hardener at specified flow rates, and the resulting paint composition, mixed in a specified ratio, is supplied through a paint pipe to a coating apparatus which is mounted, for example, on an arm of a coater manipulation robot (e.g., as disclosed in Patent Literature 1: Japanese Patent Laid-Open No. S59-213468).

Normally, a coating apparatus is supplied with a well-mixed paint composition from a mixer mechanism which is generally referred to as “a static mixer” or “line mixer”, which is located at a junction point on a downstream side of a main component supply line and a hardener supply line.

In the case of the two component type paint which is employed by the coating apparatus in Patent Literature 1 mentioned above, the paint starts hardening gradually from a time point when a hardener is mixed into a main component, hardening the latter to a solid state within a certain time period. Therefore, hardening occurs to paint residues which remain in paint pipes and a trigger valve which are located in a mixed paint supply passage, unless paint residues are washed off to a sufficient degree upon completion of each paint coating operation. Deposition of paint residues in a passage of paint supply will make the paint flow unstable, affecting the finish quality. In such a case, it becomes necessary to dismantle and disassemble the paint pipes and trigger valve to wash off deposited paint residues or to replace them by fresh ones at the cost of a great deal of labor and a great deal of time.

Further, a coating apparatus for the two component type paint requires a paint mixer such as “static mixer” or “line mixer” for mixing a main component and a hardener to a sufficient degree. However, the mixer mechanism of this sort employs a collisional mixer mechanism incorporating a paint passage of a complicate shape to collide two liquids against each other. Accordingly, a large amount of a wash fluid is required at the time of washing such mixer mechanism. In addition, the mixer mechanism, which is difficult to wash and susceptible to paint deposition, needs to be replaced on a regular basis although its replacement is very troublesome and time-consuming.

Further, in the case of the coating apparatus of Patent Literature 1, the mixed paint, which is obtained by mixing a main component from a main component supply line with a hardener from a hardener supply line, is supplied through a paint pipe to a coating apparatus which is mounted on an arm of a coater manipulation robot. Therefore, in the case of the coating apparatus of Patent Literature 1, the mixed paint has to be delivered to the coater body through a long paint supply passage after mixing a main component with a hardener. A long paint supply passage from a mixing point where a main component is mixed with a hardener to a coater body requires a time-consuming washing operation covering paint contacting surfaces in a broad range of the paint coating system. Besides, due to a difficulty of distributing a wash fluid to every corner of the paint supply passages, the flow area of a paint supply passage is narrowed down by deposition of paint residues, causing instability in paint flow rate and posing adverse effects on finish quality.

Further, a two component type paint is costly as compared with ordinary paint products in general which are composed of a pigment and a solvent. However, in Patent Literature 1 mentioned above, on each color change, a large amount of a two component type paint remaining in a lengthy paint supply pipe has to be discarded despite undesirable increases in running cost.

### DISCLOSURE OF THE INVENTION

In view of the above-discussed problems with the prior art, it is an object of the present invention to provide a coating apparatus for spraying a two component type paint, which is significantly reduced in length of a paint supply passages to a paint sprayer means of a main coater body from a point where a main component and a hardener are mixed with each other, permitting to shorten the time length of a washing operation and to cut the amount of discarded paint, in addition to improvements in finish quality.

It is another object of the present invention to provide a coating apparatus of the sort as mentioned above, employing a valve mount member on which respective valves can be detachably mounted in a facilitated manner, permitting to carry out overhaul washing of a valve and replacement jobs efficiently within a short time period.

(1) According to the present invention, there is provided a coating apparatus, which comprises: a main coater body having a paint sprayer means at a front end thereof; a main component valve assembly composed of a main component valve connected to a main component supply source, a wash fluid valve connected to a wash fluid supply source, and a check valve located on outlet side of the main component valve and the wash fluid valve; a hardener valve assembly composed of a hardener valve connected to a hardener supply source, a wash fluid valve connected to a wash fluid supply source, and a check valve located on outlet side of the hardener valve and wash fluid valve; and a trigger valve located on outlet side of the check valve of the main component valve assembly and the check valve of the hardener valve assembly to turn on and off supply of a main component and a hardener to the paint sprayer means of the main coater body.

In order to solve problems described hereinbefore, the coating apparatus according to the present invention comprises: a valve mount member provided at a rear end of the main coater body, and a valve retainer means adapted to detachably mount the main component valve and wash fluid valve of the main component valve assembly along with the hardener valve and wash fluid valve of the hardener valve assembly and the trigger valve on the valve mount member.

With the arrangements just described, the valve mount member can be located in a position in the proximity of the paint sprayer means on the main coater body to shorten the length of paint supply passages through which a mixed paint is conducted.

As a consequence, at the time of a color change, the range of a washing operation which is required to get rid of a previous color can be narrowed to more limited passage areas. It follows that paint residues in a narrow limited range can be washed off in an assured manner and within a shorter time period. Besides, it becomes possible to cut the amount of paint residues to be discarded on each color change. Further, since a previous color can be washed off assuredly within a short time period, paint supply passages are prevented from being narrowed by hardened paint deposition, for supplying paint in a stabilized state to guarantee satisfactory finish quality of coatings.

Further, main component valves and wash fluid valve of the main component valve assembly as well as hardener valves and wash fluid valve of the hardener valve assembly and trigger valve are detachably mounted on the valve mount member by the use of valve retainer means. Accordingly, in case a trouble occurs to a valve due to paint deposition, the valve in trouble can be dismantled easily from the valve mount member simply by loosening the valve retainer means for overhauling and washing purposes. A cleaned or fresh replacing valve can be mounted in position simply by threading the valve retainer means into the valve mount member. That is to say, when a flow of paint becomes instable due to paint deposition, a valve in trouble can be dismantled from or remounted on the valve mount member easily in a short time period, permitting to carry out maintenance jobs such as inspection, overhauling and replacing services in an efficient manner.

(2) Further, according to the invention, the valve mount member is provided with two separate circumferential zones around outer periphery thereof, and adapted to mount the main component valve and wash fluid valve of the main component valve assembly in series in one circumferential zone and to mount the hardener valve and wash fluid valve of the hardener valve assembly in series in the other circumferential zone, and the trigger valve is mounted on downstream side of the check valve of the main component valve assembly and the check valve of the hardener valve assembly.

Thus, the main component valves and wash fluid valve of the main component valve assembly as well as the hardener valves and wash fluid valve of the hardener valve assembly and the trigger valve can be mounted in an orderly around the outer periphery of the valve mount member. Accordingly, the respective valves can be quickly and readily mounted on and dismantled from the valve mount member, permitting to carry out maintenance jobs in an efficient manner. Besides, the passage connecting the respective valves can be formed simply free of redundant turn portions.

(3) Further, according to the invention, the check valve of the main component valve assembly is mounted in association with either one of the main component valve and the wash fluid valve at a junction point thereof, while the check valve of the hardener valve assembly is mounted in association with either one of the hardener valve and the wash fluid valve at a junction point thereof.

In this case, each check valve can be mounted on and dismantled from the valve mount member along with other valves, and can be built in a simplified construction.

(4) On the other hand, according to the invention, the coating apparatus may further comprise a mixer means detachably mounted on the main coater body between the trigger valve and the paint sprayer means for mixing a main component and a hardener with each other.

In this case, a main component and a hardener can be mixed with each other positively by the mixer means to guarantee satisfactory finish quality of coatings. The detachable mixer means can be replaced by a fresh one quickly in a facilitated manner.

(5) In this case, according to the invention, the main coater body is provided with an openable transparent or semi-transparent cover for covering the mixer means.

Thus, the mixer means is protected against contaminants and damages by the cover. Besides, since the cover is transparent or semi-transparent, the mixer means inside of the cover can be inspected from outside without opening the cover. If necessary, the mixer means can be replaced in a facilitated manner by opening the cover.

(6) According to the invention, the coating apparatus may further comprise a front end washing valve connected to the wash fluid supply source to turn on and off a supply of a wash fluid to the paint sprayer means of the main coater body, the front end washing valve being detachably mounted on the valve mount member by means of a valve retainer means.

Thus, upon opening the front end washing valve, the paint which has deposited on the paint sprayer means can be washed off by the wash fluids. Likewise, the front end washing valve is detachably mounted on the valve mount member by the use of a valve retainer means.

(7) According to the invention, the coating apparatus may further comprise a first switch valve located on outlet side of the check valve of the main component valve assembly, the first switch valve being switchable between a first position for supplying a main component to the trigger valve and a second position for discharging spent wash fluids to a waste liquid tank, a second switch valve located on outlet side of the check valve of the hardener valve assembly, the second switch valve being switchable between a first position for supplying a hardener to the trigger valve and a second position for discharging spent wash fluids to the waste liquid tank, and a third switch valve adapted to switch a supply of wash fluids from the wash fluid supply source either to the paint sprayer means of the main coater body or to the trigger valve, each one of the first switch valve, second switch valve and third switch valve being detachably mounted on the valve mount member by means of a valve retainer means.

Thus, at the time of supplying a main component to the trigger valve, the first switch valve is changed over to a position on the side of the trigger valve. Whereupon, a main component is supplied to the trigger valve through the check valve. At the time of discharging spent wash fluids, containing washed paint residues, to the waste liquid tank, the first switch valve is changed over to a position on the side of the waste liquid tank. Whereupon, spent wash fluids are discharged toward the waste liquid tank.

On the other hand, at the time of supplying a hardener to the trigger valve, the second switch valve is changed over to a position on the side of the trigger valve. Whereupon, a hardener is supplied to the trigger valve through the check valve. At the time of discharging spent wash fluids, containing washed paint residues, to the waste liquid tank, the second switch valve is changed over to a position on the side of the waste liquid tank. Whereupon, spent wash fluids are discharged toward the waste liquid tank.

Further, at the time of washing the paint sprayer means on the main coater body, the third switch valve is changed over to a position on the side of the paint sprayer means. Whereupon, wash fluids are sent forward toward the paint sprayer means from the wash fluid supply source to wash off the paint sprayer means clean. Further, at the time of washing the trigger valve, the third switch valve is changed over to a position on the side of the trigger valve. Whereupon, wash fluids are sent forward from the wash fluid supply source toward the trigger valve to wash off the latter clean.

In this instance, the three washing operations, i.e., an operation for washing off residues of a main component, an operation for washing off residues of a hardener and an operation for washing off residues of a mixture of a main component and a hardener, can be carried out concurrently free of any interference, permitting to shorten the washing time in the washing stage to a considerable degree.

(8) Further, according to the invention, the valve retainer means is in the form of a clamping mechanism adapted to clamp a screw member into a screw hole, in the form of a ball joint mechanism adapted to engage a retainer ball with a recessed coupling portion, in the form of an interlocking pawl mechanism adapted to lock locking pawls into locking holes, or in the form of a magnetic mechanism adapted to retain a valve in position by the use of magnets.

Thus, a suitable valve retainer means can be selected from the clamping mechanism, ball joint mechanism, interlocking pawl mechanism and magnetic mechanism, in consideration of various conditions such as specifications, construction and cost of each valve retainer means.

### BRIEF DESCRIPTION OF THE DRAWINGS

In the accompanying drawings:

FIG. 1 is a longitudinal sectional view of a rotary atomizing head type coating apparatus according to a first embodiment of the invention;

FIG. 2 is a circuit diagram showing general arrangements of the rotary atomizing head type coating apparatus of the first embodiment;

FIG. 3 is an enlarged longitudinal sectional view showing a valve mount member, a trigger valve and a front end washing valve in FIG. 1;

FIG. 4 is a left-hand side view of the valve mount member, main component valve assembly, hardener valve assembly, trigger valve and front end washing valve, taken in the direction of arrow IV-IV in FIG. 3;

FIG. 5 is a cross-sectional view of the valve mount member, main component valve assembly, hardener valve assembly, trigger valve and front end washing valve each mounted in position, taken in the direction of arrow V-V in FIG. 3;

FIG. 6 is an enlarged longitudinal sectional view of the main component valve and a check valve which are mounted on the valve mount member, taken in the direction of arrow VI-VI in FIG. 5;

FIG. 7 is a sectional view showing the valve mount member, main component valve and check valve of FIG. 6 in a disassembled state;

FIG. 8 is a time chart adopted for the rotary atomizing head type coating apparatus of the first embodiment;

FIG. 9 is a circuit diagram showing the general arrangement of the rotary atomizing head type coating apparatus according to the second embodiment of the invention;

FIG. 10 is a time chart adopted for the rotary atomizing head type coating apparatus of the second embodiment;

FIG. 11 is a longitudinal sectional view taken from the same position as FIG. 3, showing a valve mount member in a third embodiment of the invention along with a main component valve and a hardener valve;

FIG. 12 is a cross-sectional view of the main component valve, hardener valve, trigger valve and front end washing valve each mounted in position on the valve mount member, taken in the direction of arrow XII-XII in FIG. 11;

FIG. 13 is an enlarged longitudinal sectional view of the main component valve which is mounted on the valve mount member, taken in the direction of arrow XIII-XIII in FIG. 12;

FIG. 14 is a sectional view taken from the same position as FIG. 13, showing the valve mount member and the main component valve in a disassembled state;

FIG. 15 is an enlarged fragmentary sectional view showing a demarcated area A in FIG. 13;

FIG. 16 is an enlarged longitudinal sectional view taken from the same position as FIG. 6, showing a main component valve which is mounted on a valve mount member in a fourth embodiment of the invention;

FIG. 17 is a sectional view taken from the same position as FIG. 16, showing the valve mount member and main component valve of FIG. 16 in a disassembled state;

FIG. 18 is a schematic perspective view showing the main component valve of FIG. 16 alone; and

FIG. 19 is an enlarged longitudinal sectional view taken from the same position as FIG. 6, showing a main component valve which is mounted on a valve mount member in a modification according to the invention.

### BEST MODE FOR CARRYING OUT THE INVENTION

Hereafter, with reference to the accompanying drawings, the coating apparatus according to the invention is described more particularly by way of its preferred embodiments which are applied to a rotary atomizing head type coating apparatus, typical of coating apparatuses to which the present invention is applicable.

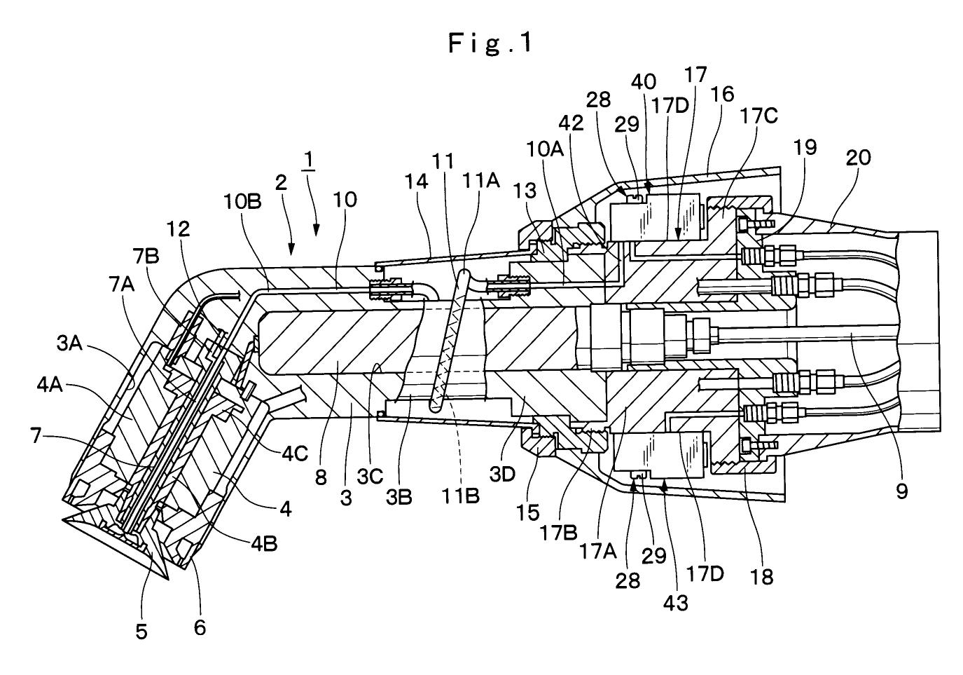

Firstly, referring to FIGS. 1 through 8, there is shown a coating apparatus in a first embodiment of the invention.

In FIG. 1, indicated at 1 is a rotary atomizing head type coating apparatus (hereinafter referred to simply as “a coating apparatus 1” for brevity) in a first embodiment of the invention. This coating apparatus 1 is adapted to spray, from a rotary atomizing head 5 which will be described hereinafter, the so-called two component type paint which is formed by mixing a hardener with a main component such as a pigment in a specific mixing ratio to serve as a hardening catalyst. The coating apparatus 1 is mounted, for example, on a distal end of an arm of a coater manipulation robot or a reciprocator (not shown). The coating apparatus 1 is largely built of a main coater body 2, a valve mount member 17, a main component valve assembly 21, a hardener valve assembly 34, a trigger valve 40 and a front end washing valve 43, which will be described hereinafter.

In this instance, the main coater body 2 of the coating apparatus 1 is built in the manner as described below.

Namely, the main coater body 2 is built as a bend type having an angularly bent front portion. Further, the main coater body 2 is largely constituted by a housing 3, an air motor 4, a rotary atomizing head 5, a shaping air ring 6, a feed tube 7, a high voltage generator 8, a paint passage 10, a mixer mechanism 11 and a mixer cover 14, which will be described later on.

Indicated at 3 is a housing which is a base structure of the main coater body 2. This housing 3 is in the form of a stepped tube which is angularly bent in a front end portion. A motor receptacle hole 3A is provided internally of a front end portion of the housing 3. In a rear portion 3D, outer periphery of the housing 3 is partly indented to provide a mixer mechanism winding portion 3B for winding therearound a mixer mechanism 11, which will be described hereinlater. On the other hand, a high voltage generator casing bore 3C is provided internally of the rear end portion 3D of the housing 3 to accommodate a high voltage generator 8 which will be described hereinafter.

The rear end portion 3D of the housing 3 is fitted in a screw projection 17B on the side of a valve mount member 17, which will be described hereinafter, and detachably fixed to the latter by threading a first retainer ring 13 onto the screw projection 17B.

Indicated at 4 is an air motor which is accommodated in the motor receptacle hole 3A of the housing 3. This air motor 4 is largely constituted by a motor case 4A, a rotational shaft 4B which is rotatably supported in the motor case 4A through an air bearing (not shown), and an air turbine 4C which is fixedly mounted on a rear end portion of the rotational shaft 4B. Compressed air is supplied to the air turbine 4C of the air motor 4 through an air supply passage (not shown) to rotate the rotational shaft 4B at a high speed.

Indicated at 5 is a rotary atomizing head which is mounted on a front end portion of the rotational shaft 4B of the air motor 4 as a paint sprayer means. This rotary atomizing head 5 is formed, for example, in a bell- or cup-like shape. Through a feed tube 7 which will be described later on, paint is supplied to the rotary atomizing head 5 which is put in high speed rotation by the air motor 4 to spray finely divided paint particles toward a work piece under the influence of centrifugal force.

Indicated at 6 is a shaping air ring which is mounted on a front end portion of the housing 3 in such a way as to circumvent the rotary atomizing head 5. This shaping air ring 6 is adapted to spurt shaping air toward outer peripheral side of the rotary atomizing head 5 to adjust a spray pattern of paint which is sprayed by the rotary atomizing head 5.

Denoted at 7 is a feed tube which is passed through the rotational shaft 4B of the air motor 4. A front end portion of this feed tube 7 is projected out of the front end portion of the rotational shaft 4B and extended into the rotary atomizing head 5. The feed tube 7 is in the form of a double tube consisting of concentric inner and outer tubes providing a paint supply passage 7A and a wash fluid supply passage 7B internally of the inner and outer tubes, respectively. A rear end portion of the feed tube 7 is fixed on a bottom portion of the motor receptacle hole 3A of the housing 3, having the inner paint supply passage 7A connected to a downstream passage section 10B of a paint passage 10, which will be described hereinafter, and the outer wash fluid supply passage 7B is connected to a wash fluid passage 12 which will also be described hereinafter. From the feed tube 7, paint or a wash fluid is spurted into the rotary atomizing head 5.

Indicated at 8 is a high voltage generator which is installed in the high voltage generator casing bore 3C of the housing 3. For example, this high voltage generator 8 is constituted by a Cockcroft circuit which is arranged to elevate a source voltage, supplied through a high voltage cable 9 from a power supply (not shown), to a high voltage of from −30 kV to −150 kV. The outlet side of the high voltage generator 8 is connected, for example, to the air motor 4 to directly charge paint with a high voltage through the rotational shaft 4B of the air motor 4.

Designated at 10 is a paint passage which is provided internally of the housing 3. From a trigger valve 40 which will be described hereinlater, paint is supplied to the paint passage 10 via a spiral tube 11A of a mixer mechanism 11 for supply to the feed tube 7. In this instance, the paint passage 10 is composed of an upstream passage section 10A on the upstream side (on the posterior side), a downstream passage section 10B on the downstream side (on the anterior side), and a spiral tube 11A. The upstream passage section 10A of the paint passage 10 is connected to an outlet side of a trigger valve 40, while the downstream passage section 10B is connected to the paint supply passage 7A of the feed tube 7.

Denoted at 11 is a mixer mechanism as a mixer means which is detachably mounted on a rear portion of the housing 3. This mixer mechanism 11 is located in an intervening position between the trigger valve 40 and the rotary atomizing head 5 of the main coater body 2. By this mixer mechanism 11, a two component type paint in circulation through the paint passage 10 is stirred up to mix a main component of a paint composition uniformly with a hardener. The mixer mechanism 11 is constituted by the spiral tube 11A which is formed of a transparent or semi-transparent synthetic resin material, and mixing members 11B which are provided internally of the spiral tube 11A.

In this instance, the spiral tube 11A is helically wound around the mixer mechanism winding portion 3B on the housing 3, an upstream end of the spiral tube 11A being disconnectibly connected to the upstream passage section 10A of the paint passage 10 while the other downstream end of the spiral tube 11A being disconnectibly connected to the downstream passage section 10B of the paint passage 10. Thus, the spiral tube 11A also serves to elongate a distance of electrical resistance to prevent leaks of a high voltage which might occur in case paint of low electrical resistance is charged with a high voltage on the rotary atomizing head 5.

Further, the mixing members 11B which are provided internally of the spiral tube 11A are of the sort which is generally referred to as “a static mixer” or “a line mixer” having a plural number of plates arranged in such a way as to cause disturbances in a paint flow, for example, as described in Japanese Patent Laid-Open No. S59-166232. Simply by passing paint through the spiral tube 11A, a main component of paint and a hardener are mixed with each other uniformly by the mixing members 11B.

In this instance, the mixer mechanism 11 which is complicated in internal shape by the existence of the mixing members 11B is difficult to wash thoroughly in an assured manner at the time of a color change, and paint residues might remain trapped on and around the mixing members 11B. In order to solve this problem, the spiral tube 11A is formed of a transparent or semi-transparent material, permitting to check for internal conditions of the spiral tube 11A (to check for a flow passage area which is narrowed by paint deposition) easily by an eye inspection from outside. When it is found by an eye inspection that there is a considerable amount of paint deposition internally of the spiral tube 11A, the mixer mechanism 11 can be easily replaced by a fresh one.

Indicated at 12 is a wash fluid passage which is provided internally of the housing 3. This wash fluid passage 12 serves to deliver to the wash fluid supply passage 7B of the feed tube 7 a wash fluid (such as wash air, a wash solvent or the like) which is supplied from a front end washing valve 43, which will be described hereinafter.

Indicated at 13 is a first retainer ring for joining the main coater body 2 with a valve mount member 17 which will be described hereinafter. The first retainer ring 13 is formed in a stepped tubular shape, and fitted on the outer periphery of the rear end portion 3D of the housing 3 so that the main coater body 2 can be detachably joined with the valve mount member 17 by threading the first retainer ring 13 onto a screw projection 17B on the side of the valve mount member 17.

Denoted at 14 is an openable mixer cover which is formed in a round tubular shape and is fitted in such a way as to enshroud the outer periphery of the mixer mechanism 11. This mixer cover 14 is so arranged as to cover the mixer mechanism winding portion 3B of the housing 3 from outside to prevent paint deposition on the mixer mechanism 11, at the same time protecting the mixer mechanism 11 from damages which may result from a colliding contact with an obstacle. The mixer cover 14 is formed of a transparent or semi-transparent material to permit eye inspection of the spiral tube 11A and mixing members 11B of the mixer mechanism 11 from outside.

In this instance, by the use of a second retainer ring 15, the mixer cover 14 is detachably fixed on the outer periphery of the first retainer ring 13 (on the housing 3). Thus, after loosening and removing the second retainer ring 15, the mixer cover 14 can be slid forward and opened at the time of replacement of the mixer mechanism 11.

Designated at 16 is a valve cover which is provided around the outer periphery of the first retainer ring 13. This valve cover 16 is formed generally in a tubular form and extended rearward to enshroud valves 22, 30, 35 and 36, trigger valve 40 and front end washing valve 43 on a valve mount member 17, which will be described hereinafter. Further, the valve cover 16 is formed of a transparent or semi-transparent material, permitting to inspect the valves 22, 30, 35 and 36, trigger valve 40 and front end washing valve 43 from outside without removing the valve cover 16. Furthermore, after loosening and removing the second retainer ring 15, the valve cover 16 can be slid open in a forward direction, permitting an access to each one of the valves 22, 30, 35 and 36, trigger valve 40 and front end washing valve 43 at the time of maintenance or at the time of replacement of a valve.

Now, a valve mount member 17 which is attached to the rear end of the main coater body 2 is constructed in the manner as described below.

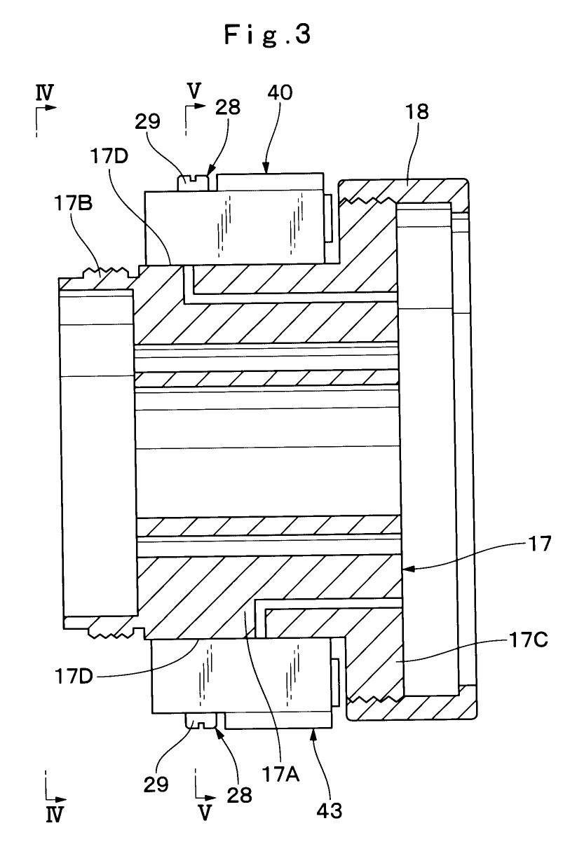

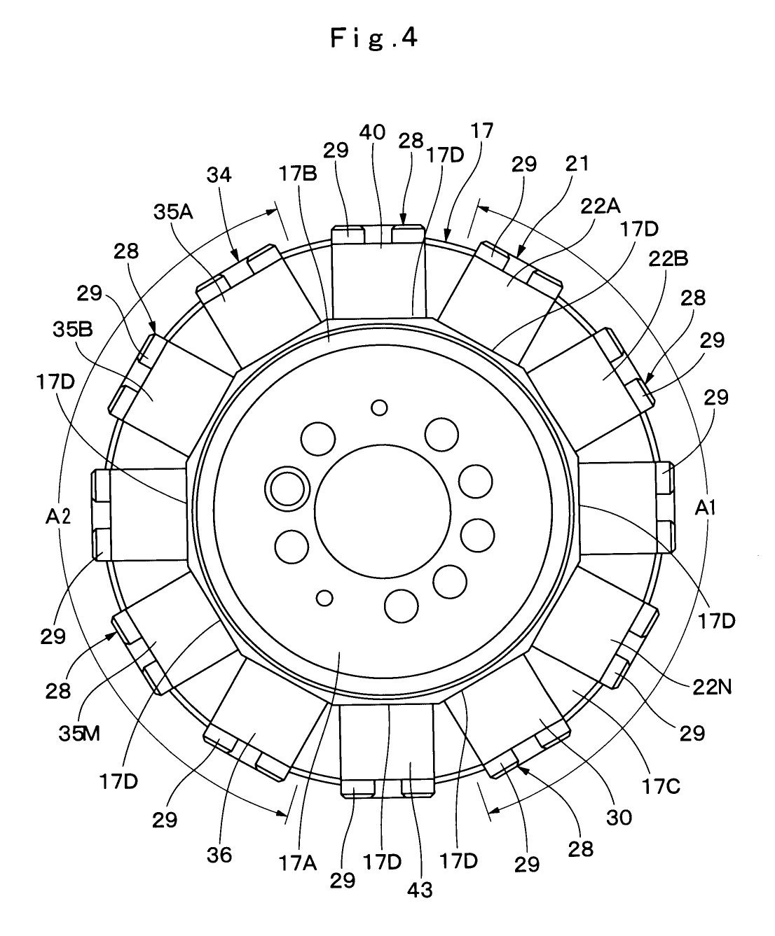

As shown in FIGS. 3 and 4, the valve mount member 17 is arranged to mount on the outer periphery thereof respective main component valves 22 of a main component valve assembly 21 along with a wash fluid valve 30, respective hardener valves 35 of a hardener valve assembly 34, a wash fluid valve 36, a trigger valve 40 and a front end washing valve 43 which will be described hereinlater. In this first embodiment, by way of example twelve valve units are mounted radially in a circular formation along the outer periphery of the valve mount member 17, including a color A main component valve 22A, a color B main component valve 22B, a color N main component valve 22N, a wash fluid valve 30, a type a hardener valve 35A, a type b hardener valve 35B, a type m hardener valve 35M, a wash fluid valve 36, a trigger valve 40, and a front end washing valve 43. That is to say, the valve mount member 17 is formed in a dodecagonal shape, with twelve valve mount segments at uniform angular intervals around its outer periphery for mounting the respective valves 22, 30, 35, 36, 40 and 43 mentioned above.

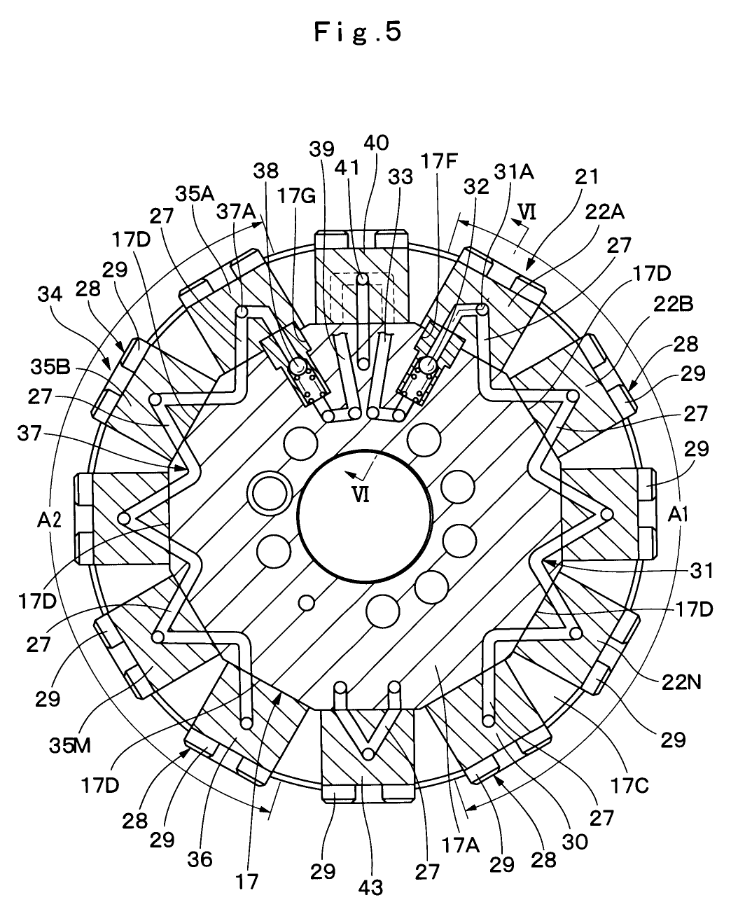

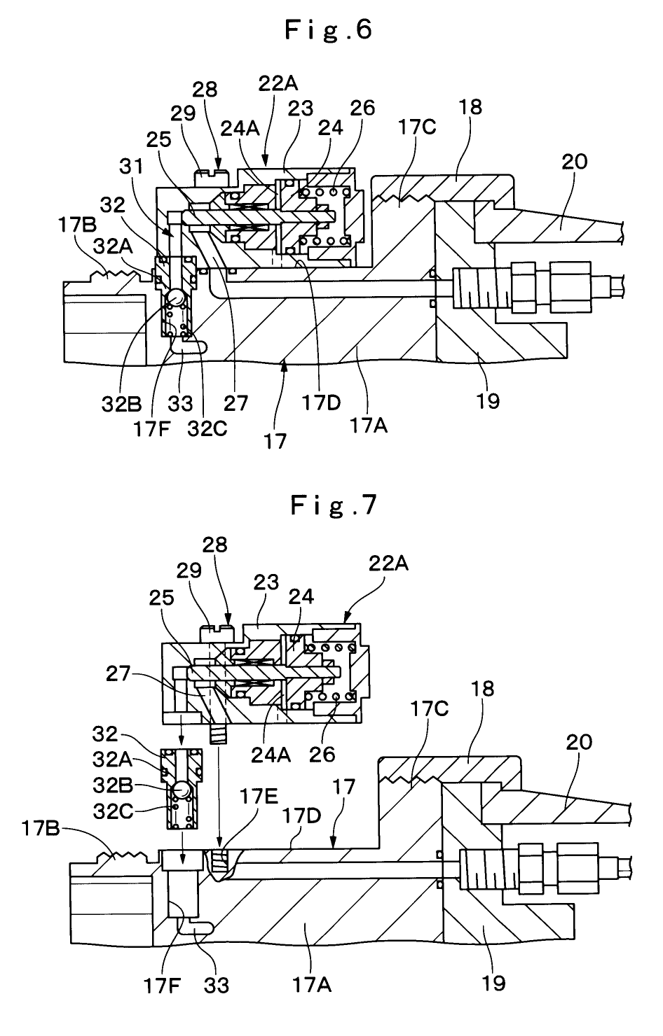

The valve mount member 17 is largely built of a main body 17A of a thick cylindrical shape, a relatively thin screw projection 17B which is projected forward from the main body 17A, and a large diameter portion 17C which is provided at the rear end of the main body 17A. The outer periphery of the main body 17A is formed in a dodecagonal shape providing twelve substantially flat mount surfaces 17D. Twelve screw holes 17E are tapped in the mount surfaces 17D (one of the twelve screw holes 17E being shown in FIG. 7) for fixing in position the valves 22, 30, 35, 36, 40 and 43 which will be described hereinafter. As shown in FIGS. 5 and 6, check valve casing bores 17F and 17G are formed in the two mount surfaces 17D for the color A main component valve 22A and the type a hardener valve 35A to accommodate therein check valves 32 and 38 which will be described hereinafter.

A rear plate 19 is attached to the rear side of the valve mount member 17 by means of a third retainer ring 18, and the valve mount member 17 is mounted, for example, on a distal end of a coater manipulation robot arm through a connector member 20 which is fixed to the rear plate 19.

Now, the main component valve assembly 21 on the valve mount member 17 is arranged in the manner as described below.

The main component valve assembly 21 functions to feed a selected color or a wash fluid to a trigger valve 40 which will be described hereinafter. Further, as shown in FIG. 4, the main component valve assembly 21 is located in a circumferential zone A1, which is one of circumferential zones A1 and A2 around the outer periphery of the main body 17A of the valve mount member 17, namely, one of circumferential zones A1 and A2 between a trigger valve 40 and a front end washing valve 43 which will be described later on. The main component valve assembly 21 is largely constituted by a plural number of main component valves 22, for supply of different paint colors, which are connected to a main component supply source 45 through a main component feeder 46, including a color A main component valve 22A, a color B main component valve 22B through to a color N main component valve 22N, one wash fluid valve 30 which is connected to a wash fluid supply source 53 through a first wash fluid selector valve 54, and one check valve 32 which is located on the outlet side of the color A main component valve 22A, color B main component valve 22B, color N main component valve 22N and wash fluid valve 30.

Indicated at 22A, 22B through 22N are main component valves (hereinafter collectively referred to as “main component valves 22”) which are mounted on the valve mount member 17 to feed main components containing pigments of color A, color B and color N, respectively. As shown in FIG. 4, these main component valves 22 are located in the circumferential zone Al between the trigger valve 40 and the front end washing valve 43. More specifically, the color A main component valve 22A, color B main component valve 22B and color N main component valve 22N are successively mounted in that order in a clockwise direction on a series of mount surfaces 17D (on a series of four mount surfaces 17D in the particular example shown) ensuing from a mount surface 17D on which the trigger valve 40 is mounted.

Further, all of the main component valves 22 are constructed substantially in the same way, so that the construction of the color A main component valve 22A which is located next to the trigger valve 40 alone is explained in the following description as a representative, omitting descriptions in this respect with regard to other color B and color N main component valves 22B and 22N which are constructed similarly to the color A main component valve 22A. Namely, the color A main component valve 22A is built as an air-piloted on-off valve, having an assembly of a piston 24 and a valve member 25 which are put in a sliding displacement together within a valve casing 23 in the shape of a rectangular parallelepiped, as shown in FIGS. 6 and 7. Normally, under the influence of a biasing action of a valve spring 26, a passage 27 for a color A main component is blocked by the valve member 25 against communication with a common passage 31, which will be described hereinafter. On the other hand, as soon as pilot air is supplied to a pressure receiving chamber 24A of the piston 24, the valve member 25 is displaced against the action of the valve spring 26 to communicate the passage 27 for a color A main component with the common passage 31.

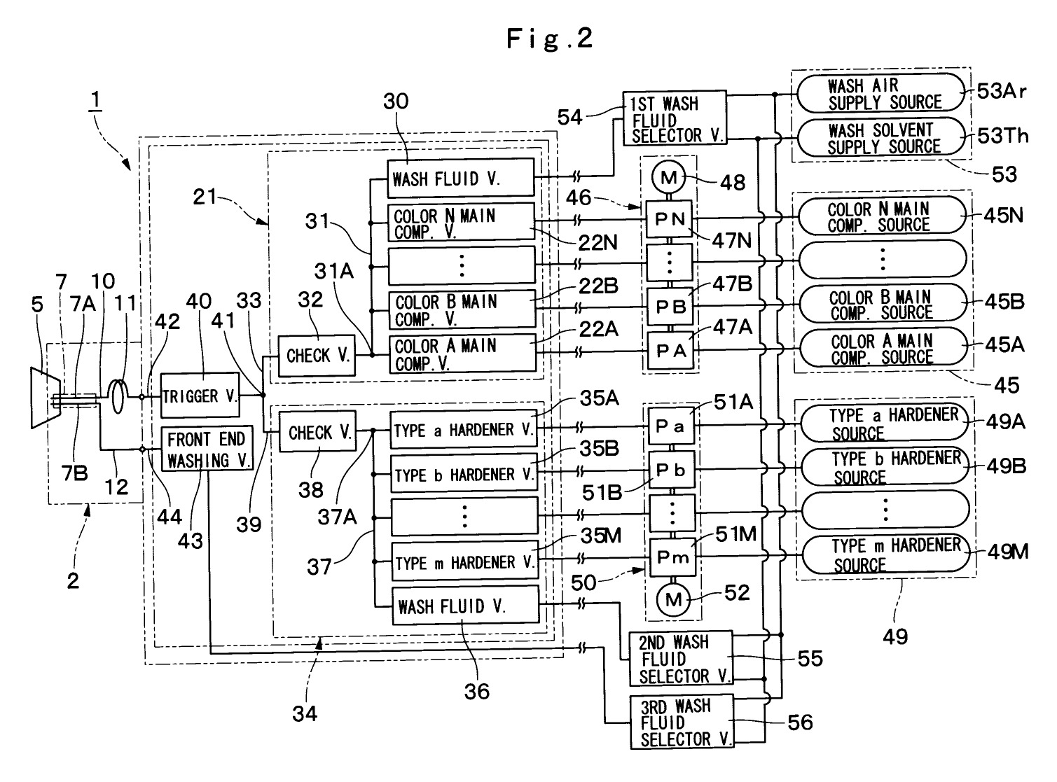

The color A main component valve 22A is detachably mounted on a mount surface 17D on the valve mount member 17 by placing its valve casing 23 in abutting engagement with the mount surface 17D from outside and threading and tightening a screw member 29 described hereinlater into a screw hole 17E on the side of the valve mount member 17 through the valve casing 23. Whereupon, as shown in FIG. 2, the color A main component valve 22A is connected to a color A main component source 45A of the main component supply source 45 through a color A main component pump 47A of a main component feeder 46, which will be described hereinafter. Similarly, the color B main component valve 22B and color N main component valve 22N are connected to a color B main component source 45B and a color N main component source 45N of the main component supply source 45 through a color B main component pump 47B and a color N main component pump 47N of the main component feeder 46.

Indicated at 28 are a plural number of clamping mechanisms which are provided on the outer peripheral side of the valve mount member 17 as valve retainer means, clamping the respective valves securely in position on the valve mount member 17. Namely, by the clamping mechanisms 28, the respective main component valves 22 of the main component valve assembly 21, and the wash fluid valve 30, the respective hardener valves 35 of the hardener valve assembly 34, and the wash fluid valve 36, the trigger valve 40 and the front end washing valve 43 are fixed in position on the valve mount member 17. In the particular embodiment shown, each clamping mechanism 28 is constituted by one of the afore-mentioned screw holes 17E tapped into the valve mount surfaces 17D of the valve mount member 17, and a screw member 29 to be threaded into one of the screw holes 17E. More specifically, the screw member 29 of the clamping mechanism 28 is inserted into a valve casing 23 radially from outside and threaded into a screw hole 17E to detachably fix, for example, a main component valve 22 on a mount surface 17D.

Indicated at 30 is a wash fluid valve which is mounted on the valve mount member 17. Along with the color A main component valve 22A, color B main component valve 22B and color N main component valve 22N, this wash fluid valve 30 is located in the circumferential zone Al at one side of the outer periphery of the main body 17A of the valve mount member 17. More particularly, as shown in FIG. 4, the wash fluid valve 30 is located between the color N main component valve 22N and the front end washing valve 43, and detachably fixed on a mount surface 17D of the valve mount member 17 from outside by means of a screw member 29. Since the wash fluid valve 30 is built similarly to the color A main component valve 22A in construction, a detailed description in this regard is omitted here. The wash fluid valve 30 is connected to a wash fluid supply source 53 through a first wash fluid selector valve 54, which will be described hereinlater.

Further, denoted at 31 is a common passage (see FIGS. 2 and 5) on the side of the main component, which is formed in such a way as to interlink the main body 17A of the valve mount member 17 and the color A main component valve 22A, color B main component valve 22B, color N main component valve 22N and wash fluid valve 30 respectively. This common passage 31 on the side of the main component is formed in such a way as to interconnect the passages 27 which are provided respectively in the wash fluid valve 30, the color A main component valve 22A, the color B main component valve 22B and the color N main component valve 22N. More particularly, the common passage 31 is extended from the passage 27 of the wash fluid valve 30 via the color N main component valve 22N and color B main component valve 22B as far as the outlet side of the color A main component valve 22A. And the outlet side of the color A main component valve 22A forms the junction point 31A of the common passage 31.

Indicated at 32 is a check valve which is provided on the outlet side of the respective main component valves 22 and wash fluid valve 30. This check valve 32 functions to prevent a hardener from flowing in a reverse direction toward the main component valve assembly 21 from the side of the hardener valve assembly 34, which will be described hereinafter. Namely, as shown in FIG. 2, the check valve 32 is located at the junction point 31A of the common passage 31 interlinking the respective main component valves 22 and the wash fluid valve 30. Further, as shown in FIGS. 6 and 7, the check valve 32 is accommodated in a check valve casing bore 17F in the valve mount member 17 and retained in position by the color A main component valve 22A which is mounted on a mount surface 17D.

The check valve 32 is composed of a valve seat 32A of a stepped cylindrical shape, a ball valve 32B to be seated on and off the valve seat 32A, and a valve spring 32C biasing the ball valve 32B in a closing direction. Thus, the check valve 32 permits a main component or a wash fluid to flow in the direction of an outlet passage 33 while blocking a reverse fluid flow.

Now, following is a description on the hardener valve assembly 34 which is mounted on the valve mount member 17.

This hardener valve assembly 34 is arranged to supply either a hardener selected from a plural number of different types of hardeners or a wash fluid to a trigger valve 40 which will be described hereinafter. As shown in FIG. 4, the hardener valve assembly 34 is located in the other circumferential zone A2 along the opposite side of the outer periphery of the main body 17A of the valve mount member 17 between the trigger valve 40 and front end washing valve 43, which will be described later on. Namely, the hardener valve assembly 34 is located in a circumferential zone A2 on the left side of the valve mount member 17 in FIG. 4. The hardener valve assembly 34 is composed of a plural number of hardener valves 35, e.g., a type a hardener valve 35A, a type b hardener valve 35B and a type m hardener valve 35M each connected to a hardener supply source 49 through a hardener feeder 50, which will be described hereinafter, a wash fluid valve 36 connected to a wash fluid supply source 53 through a second wash fluid selector valve 55, and a check valve 38 which is provided on the outlet side of the hardener valves 35A, 35B and 35M and the wash fluid valve 36.

Indicated at 35A, 35B and 35M are a plural number of hardener valves 35 which are mounted on the valve mount member 17 for supply of different types of hardeners, e.g., type a hardener valve 35A, a type b hardener valve 35B and a type m hardener valve 35M (hereinafter collectively referred to as “hardener valves 35” for brevity). As shown in FIG. 4, the hardener valves 35 are located in a circumferential zone A2 on the left side between the trigger valve 40 and front end washing valve 43. More particularly, the type a hardener valve 35A, type b hardener valve 35B and type m hardener valve 35M are located successively in that order in a counterclockwise direction on a series of mount surfaces 17D (on a series of four mount surfaces 17D in the particular embodiment shown) ensuing from a mount surface 17D on which the trigger valve 40 is mounted.

Further, each one of the hardener valves 35 is constructed substantially in the same way as the above-described main component valves 22, so that a detailed description in this regard is omitted here. In this instance, each hardener valve 35 is detachably mounted on a mount surface 17D of the valve mount member 17 by placing a valve casing in abutting engagement with the mount surface 17D from outside and then threading a screw member 29 of a clamping mechanism 28 into a screw hole 17E on the side of the valve mount member 17. As a consequence, as shown in FIG. 2, the type a hardener valve 35A, type b hardener valve 35B and type m hardener valve 35M are connected to type a hardener source 49A, a type b hardener source 49B and a type m hardener source 49M of a hardener supply source 49 through a type a hardener pump 51A, a type b hardener pump 51B and a type m hardener pump 51M of a hardener feeder 50, respectively.

Indicated at 36 is a wash fluid valve which is mounted on the valve mount member 17. Along with the hardener valves 35, this wash fluid valve 36 is located in the circumferential zone A2 along one side of the outer periphery of the valve mount member 17. More specifically, the wash fluid valve 36 is located in a position between the type m hardener valve 35M and the front end washing valve 43, and detachably fixed on a mount surface 17D on the valve mount member 17 by threading a screw member 29 from outside. The wash fluid valve 36 is constructed substantially in the same way as the above-described color A main component valve 22A, so that a detailed description in this regard is omitted here. By way of a second wash fluid selector valve 55 which will be described hereinafter, the wash fluid valve 36 is connected to a wash fluid supply source 53.

Further, indicated at 37 is a common passage on the side of the hardener, which is formed in such a way as to interlink the main body 17A of the valve mount member 17 and the hardener valves 35 and the wash fluid valve 36. This common passage 37 on the side of the hardener is formed in such a way as to interconnect the passages 27 which are provided respectively in the wash fluid valve 36, the type m hardener valve 35M, the type b hardener valve 35B and the type a hardener valve 35A. And the outlet side of the type a hardener valve 35A forms the junction point 37A of the common passage 37.

Denoted at 38 is a check valve which is provided on the outlet side of the respective hardener valves 35 and the wash fluid valve 36. This check valve 38 is built in the same manner as the above-described check valve 32. As shown in FIG. 5, the check valve 38 is located at the junction point 37A of the common passage 37 interlinking the respective hardener valves 35 and the wash fluid valve 36 with each other. The check valve 38 is accommodated in a check valve casing bore 17G on the valve mount member 17 in association with the type a hardener valve 35A which is mounted on a mount surface 17D, permitting a flow of a hardener or of a wash fluid in a direction toward an outlet passage 39 while blocking a flow in a reverse direction.

Now, following is a description on constructions of trigger valve 40 and front end washing valve 43 which are mounted in radially opposing positions on the valve mount member 17.

Namely, indicated at 40 is a trigger valve which is mounted on the valve mount member 17 to turn on and off supply of a two component type paint to the rotary atomizing head 5. This trigger valve 40 is located in a position downstream of the check valve 32 of the main component valve assembly 21 and the check valve 38 of the hardener valve assembly 34. Namely, the trigger valve 40 is located at a junction point 41 of an outlet passage 33 of the check valve 32 and an outlet passage 39 of the check valve 38. Further, the trigger valve 40 is built substantially in the same manner as the above-described color A main component valve 22A, and its outlet side is connected to the paint passage 10 in the housing 3 through an outlet passage 42. Thus, the trigger valve 40 functions to turn on and off a supply of a main component from the main component valve assembly 21 as well as a supply of a hardener from the hardener valve assembly 34 to the rotary atomizing head 5 of the main coater body 2.

As shown in FIG. 5, the trigger valve 40 is located between the color A main component valve 22A and the type a hardener valve 35A, and detachably fixed in position on a mount surface 17D from outside by a screw member 29 of a clamping mechanism 28.

Indicated at 43 is a front end washing valve which is mounted on the valve mount member 17 for the purpose of washing a fore distal end portion of the feed tube 7. This front end washing valve 43 is built substantially in the same manner as the above-mentioned color A main component valve 22A, with its outlet side communicated with a wash fluid passage 12 in the housing 3 through an outlet passage 44. Thus, the front end washing valve 43 functions to turn on and off a supply of a wash fluid to the rotary atomizing head 5 of the main coater body 2 from the wash fluid supply source 53 through the third wash fluid selector valve 56. As shown in FIG. 5, the front end washing valve 43 is detachably mounted from outside on a mount surface 17D on the valve mount member 17 at a position between the wash fluid valves 30 and 36 by a screw member 29.

In the manner as described above, the main component valve assembly 21, hardener valve assembly 34, trigger valve 40 and front end washing valve 43 are mounted on the valve mount member 17 which is located adjacently to the main coater body 2. Therefore, a washing operation which is required upon a color change can be narrowed to a smaller range (in total length of paint passage), permitting to wash off two component type paint efficiently in a concentrated manner. In contrast, main component supply source 45, main component feeder 46, hardener supply source 49, hardener feeder 50, wash fluid supply source 53, wash fluid selector valves 54, 55 and 56 in paint and wash fluid supply systems in the following description are each installed, for example, in a position in the vicinity of the coater manipulation robot away from the main coater body 2.

Main components, hardeners and wash fluid are supplied to the coating apparatus 1 by way of separate supply lines as described below.

Firstly, indicated at 45 is a main component supply source in the role of supplying sources of respective main components of different colors. This main component supply source 45 comprises a color A main component source 45A, a color B main component source 45B through to a color N main component source 45N to supply main components of colors A, B and N, respectively. By way of a main component feeder 46 which will be described hereinafter, the main component supply source 45 is connected to the respective main component valves 22 of the main component valve assembly 21.

Indicated at 46 is a main component feeder which is connected with the main component supply source 45 and the respective main component valves 22 of the main component valve assembly 21. This main component feeder 46 is composed of a color A main component pump 47A, a color B main component pump 47B through to a color N main component pump 47N (hereinafter collectively referred to as “main component pumps 47” for brevity) which are connected to the color A main component valve 22A, color B main component valve 22B and color N main component valve 22N, respectively, and a motor 48 which is selectively connective to one of the main component pumps 47 through a clutch (not shown). A displacement type pump, e.g., a gear pump, is used for each one of the main component pumps 47.

Further, the color A main component pump 47A, color B main component pump 47B and color N main component pump 47N of the main component feeder 46 are connected to the color A main component source 45A, color B main component source 45B and color N main component source 45N of the main component supply source 45, respectively. In this instance, each one of the main component pumps 47 is in a role of supplying a specific main component at a higher feed rate as compared with hardener pumps 51, which will be described hereinafter. Namely, the main component pumps 47 are adapted and driven to deliver a main component at a higher feed rate per unit time as compared with a hardener feed rate by the hardener pumps 51. The motor 48 is a variable speed motor which is capable of variably controlling its outlet speed, and connectible to one of the main component pumps 47 connected through clutch to drive same at a specified feed rate depending upon conditions of a paint coating operation.

Indicated at 49 is a hardener supply source for a number of hardeners of different types. This hardener supply source 49 comprises a type a hardener source 49A, a type b hardener source 49B through to a type n hardener source 49N for supply of a type a, type b and type n hardeners, respectively. Through a hardener feeder 50 which will be described hereinlater, the hardener supply source 49 is connected to the respective hardener valves 35 of the hardener valve assembly 34.

Denoted at 50 is a hardener feeder which is connected between the hardener supply source 49 and the hardener valve assembly 34. This hardener feeder 50 is composed of a type a hardener pump 51A, a type b hardener pump 51B through to a type m hardener pump 51M (hereinafter collectively referred to as “hardener pumps 51” for brevity) which are connected to the type a hardener valve 35A, type b hardener valve 35B and type m hardener valve 35M, respectively, and a motor 52 which is selectively connectable to one of the hardener pumps 51 through a clutch (not shown) for driving same. A displacement type pump such as a gear pump, for example, is used for each one of the hardener pumps 51.

The type a hardener pump 51A, type b hardener pump 51B and type m hardener pump 51M of the hardener feeder 50 are connected to the type a hardener source 49A, type b hardener source 49B and type m hardener source 49M of the hardener supply source 49, respectively. In this instance, each one of the hardener pumps 51 is in a role of supplying a hardener of a specific type at a lower feed rate as compared with a main component feed rate. Namely, the hardener pumps 51 are adapted and driven to deliver a hardener at a lower feed rate per unit time as compared with the main component pumps 47. Thus, each one of the hardener pumps 51 can be put in operation at an appropriate rotational speed permitting the stable supply of accurate amount of a hardener even when delivering a hardener at a small feed rate. Further, similarly to the motor 48 of the main component feeder 46, the motor 52 is a variable speed motor which is capable of variably controlling its outlet speed, and connectible to one of the hardener pumps 51 through a clutch to control the delivery rate of the pump depending upon conditions of a paint coating operation.

Indicated at 53 is a wash fluid supply source which is in a role of supplying a wash fluid. This wash fluid supply source 53 is composed of a wash air supply source 53Ar and a wash solvent (a thinner) supply source 53Th. Through first to third wash fluid selector valves 54, 55 and 56, this wash fluid supply source 53 is connectable to the wash fluid valve 30 of the main component valve assembly 21, the wash fluid valve 36 of the hardener valve assembly 34 and the front end washing valve 43, respectively.

Indicated at 54 is a first wash fluid selector valve which is connected between the wash fluid supply source 53 and the wash fluid valve 30 of the main component valve assembly 21. For example, this wash fluid selector valve 54 is constituted by single 3-port 2-position directional control valve or a combination of a couple of 2-port 2-position directional control valves. Further, the wash fluid selector valve 54 is connected to the wash air supply source 53Ar and wash solvent supply source 53Th of the wash fluid supply source 53. Wash air and a wash solvent are supplied from the first wash fluid selector valve 54 at the time of washing off paint residues in the common passage 31 and check valve 32 on the side of the main component valves, or at the time of washing off residues of a previous color in the trigger valve 40, paint passage 10, mixer mechanism 11 and feed tube 7.

Indicated at 55 is a second wash fluid selector valve which is connected between the wash fluid supply source 53 and the wash fluid valve 36 of the hardener valve assembly 34. Similarly to the above-described first wash fluid selector valve 54, for example, the wash fluid selector valve 55 which is connected to the wash air supply source 53Ar and the wash solvent supply source 53Th can be constituted by a single 3-port 2-position directional control valve or a combination of a couple of 2-port 2-position directional control valve. Wash air and wash solvent are supplied from the second wash fluid selector valve 55 at the time of washing off hardener residues in the common passage 37 and check valve 38 on the side of the hardener valves or at the time of washing of f residues of a previous color in the trigger valve 40, paint passage 10, mixer mechanism 11 and feed tube 7.

Designated at 56 is a third wash fluid selector valve which is connected between the wash fluid supply source 53 and the front end washing valve 43. Similarly to the above-described first wash fluid selector valve 54, for example, this wash fluid selector valve 56 which is connected to the wash air supply source 53Ar and the wash solvent supply source 53Th can be constituted by a single 3-port 2-position directional control valve or a combination of a couple of 2-port 2-position directional control valve. Wash air and wash solvent are supplied from the third wash fluid selector valve 56 at the time of washing off paint deposits of a previous color on the rotary atomizing head 5.

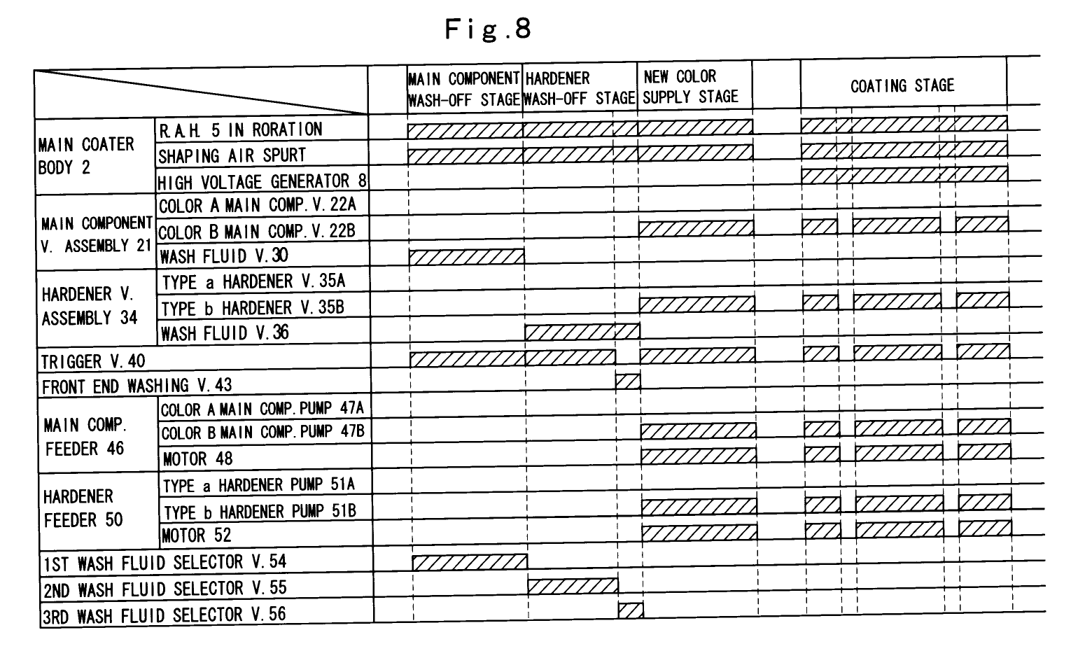

Being arranged in the manner as described above, the coating apparatus 1 of the first embodiment is put in action for a paint coating operation, controlling various operating parts of the machine in predetermined timings as shown in the time chart of FIG. 8.

In the first place, upon completion of a paint coating operation with a previous color (e.g., with a two component type paint containing a main component of color A mixed with a type a hardener), the machine is now put in actions for a color change (e.g., to another two component type paint containing a main component of color B mixed with a type b hardener) in the manner as follows. Described below by way of example is a color changing operation which is composed of three stages in the order of “a main component wash-off stage”, “a hardener wash-off stage”, and “a new color supply stage”. Needless to say, the main component wash-off stage and hardener wash-off stage may be carried out in a reversed order if desired.

Firstly, the main component wash-off stage is started with opening the wash fluid valve 30 of the main component valve assembly 21, the trigger valve 40 and the first wash fluid selector valve 54 for the purpose of washing off residues of the main component of a color A from the common passage 31 on the side of the main component valves, check valve 32, outlet passage 33, trigger valve 40, paint passage 10 on the main coater body 2, mixer mechanism 11 and paint supply passage 7A of the feed tube 7. During the color changing operation from the main component wash-off stage through to the new color supply stage, the rotary atomizing head 5 is put in rotation, and shaping air is spurted out from the shaping air ring 6.

As a consequence, by the wash air and wash solvent from the wash air supply source 53Ar and wash solvent supply source 53Th of the wash fluid supply source 53, the check valve 32 is pushed open to wash off residues of a previous color A in the common passage 31, discharging residues of the color A from the paint supply passage 7A of the feed tube 7 toward the rotary atomizing head 5 through the paint passage 10. At this time, the rotary atomizing head 5 is washed clean by the wash air and wash solvent. As soon as the previous color A has been washed off, the wash fluid valve 30 as well as the first wash fluid selector valve 54 is closed.

Now, in the next hardener wash-off stage, the wash fluid valve 36 of the hardener valve assembly 34 and the second wash fluid selector valve 55 are opened to wash off residues of a type a hardener in the common passage 37 and outlet passage 39. Whereupon, by the wash air and wash solvent from the wash fluid supply source 53, the check valve 38 is pushed open to wash off residues of the type a hardener in the common passage 37, discharging the residues of the type a hardener toward the rotary atomizing head 5 from the paint supply passage 7A of the feed tube 7 through the paint passage 10 to wash the rotary atomizing head 5 at the same time. As soon as the type a hardener has been washed off, the wash fluid valve 36 as well as the second wash fluid selector valve 55 is closed.

In this instance, in both of the above-described washing operations getting rid of residues of the main component of color A and the type a hardener, all of the delivered wash fluids are passed through the paint passage 10 to wash off paint residues from the complicatedly arranged mixing members 11B of the mixer mechanism 11 effectively by the use of a smaller amount of wash fluids, through utilization of the two color A wash-off and type a hardener wash-off operations.

Further, at the end of the hardener wash-off stage, the front end washing valve 43 as well as the third wash fluid selector valve 56 is opened. Whereupon, wash air and wash solvent from the wash fluid supply source 53 are spurted toward the rotary atomizing head 5 from the wash fluid supply passage 7B of the feed tube 7 to wash off the paint residues on a fore distal end portion of the feed tube 7 and paint-contacting surfaces of the rotary atomizing head 5.

As soon as the previous color has been washed off by the preceding main component and hardener wash-off operations, a main component of color B and a type b hardener to be used in a next paint coating operation are fed up to a fore distal end portion of the feed tube 7. At this time, the color B main component valve 22B as well as the trigger valve 40 is opened, and the color B main component pump 47B of the main component feeder 46 is put in operation. As a result, the check valve 32 is opened to feed the main component of color B up to a fore distal end portion of the feed tube 7 from the paint passage 10.

Concurrently with the start of supply of the main component of color B, a type b hardener valve 35B is opened, and the type b hardener pump 51B of the hardener feeder 50 is put in operation. As a result, the check valve 38 is opened to supply a type b hardener to a fore distal end portion of the feed tube 7 from the paint passage 10 along with the main component of color A.

When the machine is put in operation for concurrent supply of the main component of color B and the type b hardener, rotational speeds of the respective pumps 47B and 51B are controlled in such a way as to feed the main component of color B or type b hardener at a maximum delivery rate up to a point in the vicinity of the check valve 32 or 38, controlling feed rates of the respective blending fractions to a predetermined ratio before reaching the junction point 41 of the trigger valve 40. By so doing, the fractions of the two component type paint can be supplied up to a fore distal end portion of the feed tube 7 in a predetermined or specified ratio in a short time period.

Now, given below is a description on a coating operation using the two component type paint with a main component of color B mixed with a type b hardener. In the first place, compressed air is fed to the air turbine 4C of the air motor 4 to put the rotary atomizing head 5 in high speed rotation along with the rotational shaft 4B. At the same time, shaping air is spurted out from the shaping air ring 6, and the high voltage generator 8 is turned on to apply a high voltage to paint on the rotary atomizing head 5. In this state, according to a shape of a work piece to be coated, the color B main component valve 22B, type b hardener valve 35B and trigger valve 40 are opened or closed while turning on or of f the pumps 47B and 51B. By so doing, a two component type paint, which is a mixture of a main component of color B and a type b hardener, is fed to the rotary atomizing head 5 from the feed tube 7 and sprayed forward from the rotary atomizing head 5 in a finely atomized form.

Now, following is a description on a maintenance work for the coating apparatus 1. Firstly, at the time of an inspection of mixer mechanism 11, conditions of the mixer mechanism 11 can be readily checked for with eyes from outside through the transparent or semi-transparent mixer cover 14. In case the mixer mechanism 11 is found to be in a trouble due to paint deposition, the mixer mechanism 11 can be dismantled and replaced by a fresh one simply by loosening the second retainer ring 15.

At the time of inspections of the color A main component valve 22A, color B main component valve 22B, color N main component valve 22N, wash fluid valve 30, type a hardener valve 35A, type b hardener valve 35B, type m hardener valve 35M, wash fluid valve 36, trigger valve 40 and front end washing valve 43 on the valve mount member 17, each valve can be checked with eyes easily through the transparent or semi-transparent valve cover 16. Further, at the time of a repair work or replacement of a valve, the valve cover 16 can be removed after loosening the second retainer ring 15. At the time of replacement of the trigger valve 40, for example, it can be dismantled and replaced by a fresh one simply by loosening the screw member 29 of the clamping mechanism 28 from an outer peripheral side.

As described above, according to the first embodiment of the invention, on and around the valve mount member 17 which is provided on the rear side of the housing 3 of the main coater body 2, the main component valve assembly 21 which is comprised of the respective main component valves 22 and a wash fluid valve 30, the hardener valve assembly 34 which is comprised of the respective of hardener valves 35 and wash fluid valve 36, trigger valve 40 and front end washing valve 43 are mounted in opposing by the use of a clamping mechanism 28. Thus, the main component valves 22 as well as the hardener valves 35 can be located closely to the rotary atomizing head 5 of the main coater body 2, shortening the length of a paint supply passage to prevent commencement of hardening reactions of a two component type paint.

It follows that the range of a washing operation, which is inevitably required to remove residues of a precious color at the time of a color change, can be narrowed to a considerable degree, thanks to a drastic reduction in length of the paint supply passage from the junction point 41 to a fore distal end portion of the feed tube 7 via the trigger valve 40 and the paint passage 10. That is to say, a washing operation on a color change is only required to wash off residues of a previous color from paint passage portions in a narrow range. This means that residues of a previous color can be washed off more thoroughly in a shorter time period.

In addition, it becomes possible to reduce the amounts of paint residues and solvent to be discarded on each color change. Besides, a previous color can be washed off in an assured manner within a short time period to prevent a flow area of a paint passage from being narrowed and constricted by paint deposition, ensuring a stable paint supply to guarantee a satisfactory finish quality.

Further, the mixer mechanism 11 is relatively complicated in an internal shape due to the existence of the mixing members 11B. However, the mixer mechanism 11 can be washed elaborately and in an economical manner by the use of the wash fluids which are flushed therethrough repeatedly at the time of washing a main component and at the time of washing a hardener, that is to say, can be washed clean effectively by the use of a reduced amount of wash fluids. Accordingly, it becomes possible to prolong the cycle of replacement of the mixer mechanism 11 and as a result to realize improvements in operational efficiency and reductions in running cost.

In addition, each one of the main component valves 22, wash fluid valves 30 and 36, hardener valves 35, trigger valve 40 and front end washing valve 43 is detachably mounted on the valve mount member 17 by a screw member 29 of a clamping mechanism 28. Therefore, in case the trigger valve 40 is troubled by paint deposition, for example, it can be easily dismantled from the valve mount member 17 simply by loosening the screw member 29, for thoroughly washing the valve in a disassembled state. A washed trigger valve 40 can be mounted again on the valve mount member 17 in a facilitated manner simply by tightening (threading) the screw member 29 into the screw hole 17E.

Thus, when a paint flow becomes instable due to paint deposition in the trigger valve 40, for example, the trigger valve 40 can be easily dismantled from and mounted again on the valve mount member 17 within a short period of time after carrying out a maintenance job, permitting to perform various maintenance jobs in an efficient manner, including inspection, overhauling and replacement of the valve.

Further, the respective main component valves 22 and wash fluid valve 30 of the main component valve assembly 21 and the respective hardener valves 35 and wash fluid valve 36 are successively allocated to separate right and left circumferential zones A1 and A2 around the outer periphery of the valve mount member 17. Thus, the respective main component valves 22 and wash fluid valve 30 of the main component valve assembly 21 as well as the respective hardener valves 35, wash fluid valve 36, trigger valve 40 and front end washing valve 43 can be located in an orderly fashion in the circumferential zone A1 or A2 around the outer periphery of the valve mount member 17. Accordingly, each one of the main component valves 22, wash fluid valves 30 and 36, hardener valves 35, trigger valve 40 and front end washing valve 43 can be mounted and dismantled quickly in a facilitated manner, permitting to perform maintenance jobs efficiently. In addition, the common passages 31 and 37 can be formed easily free from redundant turn portions.

On the other hand, the check valve 32 of the main component valve assembly 21 is mounted at the junction point 31A of the common passage 31 along with the color A main component valve 22A by means of a screw member 29. Similarly, the check valve 38 of the hardener valve assembly 34 is mounted at the junction point 37A of the common passage 37 along with the type a hardener valve 35A by means of a screw member 29. These check valves 32 and 38, which are arranged to be mounted on and dismantled from the valve mount member 17 along with the color A main component valve 22A and the type a hardener valve 35A, can be simplified in construction.

Further, the mixer mechanism 11, which is provided in the course of the paint passage 10 for the purpose of mixing a main component and a hardener, can be easily mounted or dismantled from the housing 3. Accordingly, a main component and a hardener can be mixed by mixing member 11B of the mixer mechanism 11 in a positive fashion to guarantee satisfactory finish quality. In addition, if necessary, the mixer mechanism 11 can be replaced in a short time period.

Further, the transparent or semi-transparent mixer cover 14 is openably (detachably) fitted on the main coater body 2 to protect the mixer mechanism 11 from damages and contaminants. Since the mixer cover 14 is transparent or semi-transparent, the internal mixing members 11B can be inspected from outside without removing the mixer cover 14. When necessary, the mixer mechanism 11 can be easily dismantled and replaced by a fresh one by removing the mixer cover 14.

Further, supply of wash fluids to the rotary atomizing head 5 is turned on and off by means of the front end washing valve 43. As soon as this front end washing valve 43 is opened, deposited paint on the rotary atomizing head 5 can be washed off by wash fluids in an assured manner within a short time period. Besides, the front end washing valve 43 can be mounted on the valve mount member 17 easily by the use of a screw member 29.

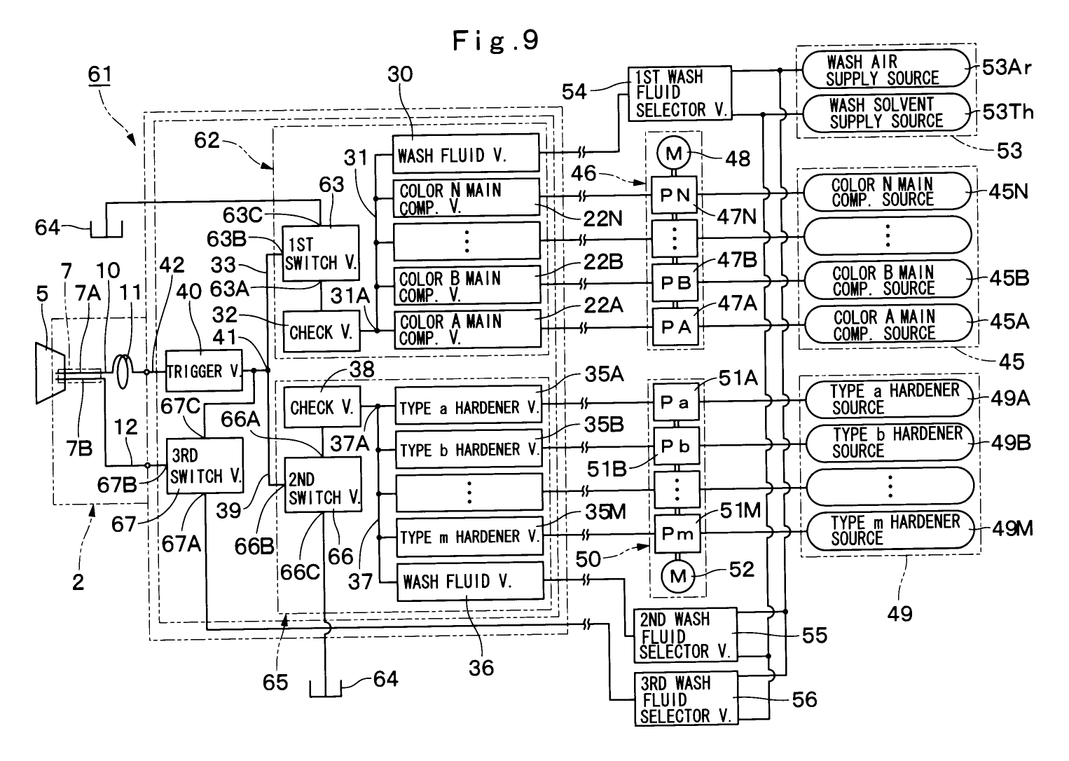

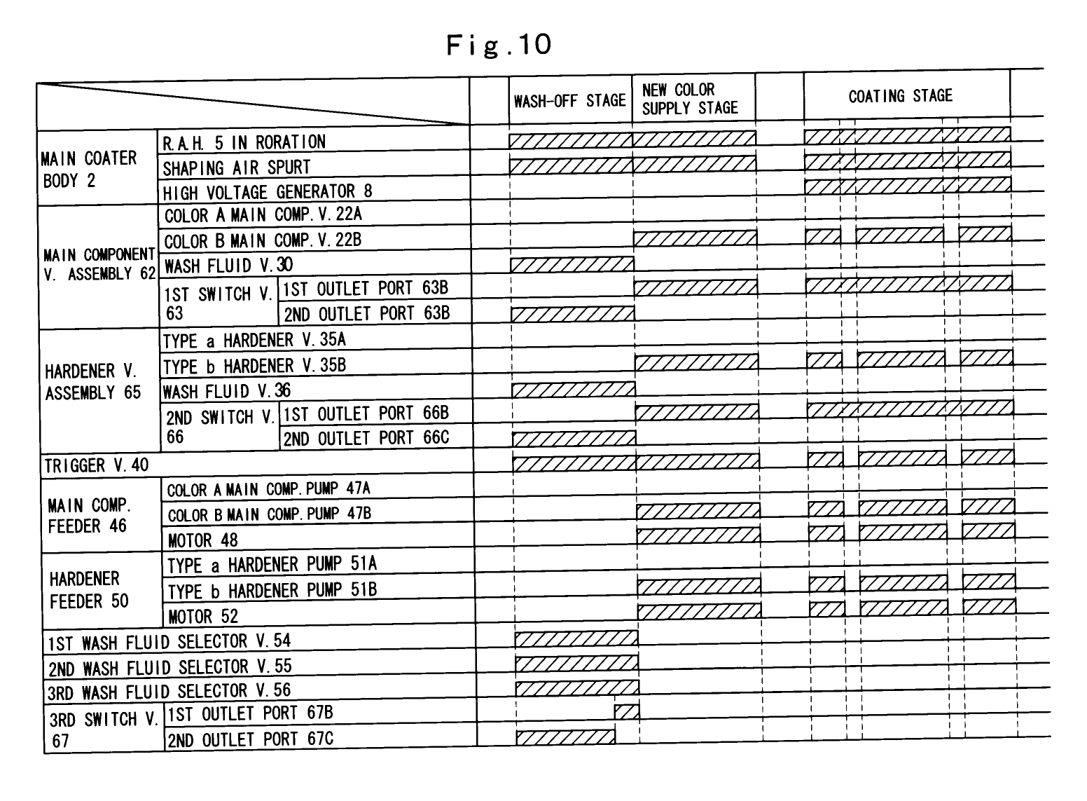

Now, turning to FIGS. 9 and 10, there is shown a coating apparatus according to a second embodiment of the invention.

This embodiment has features in that the coating apparatus comprises: a first switch valve which is located on the outlet side of a check valve of a main component valve assembly to supply a main component toward a trigger valve or to discharge spent wash fluids to a waste liquid tank; a second switch valve which is located on the outlet side of a check valve of a hardener valve assembly to supply a hardener toward the trigger valve or to discharge spent wash fluids to the waste liquid tank; and a third switch valve which is adapted to switch supply of a wash fluid, received from a wash fluid supply source, either to a paint sprayer means or to a trigger valve; each one of the first to third switch valves being detachably mounted in position on a valve mount member by means of a valve retainer means. In the following description of the second embodiment, those component parts which are identical with counterparts in the foregoing first embodiment are simply designated by the same reference numeral or character to avoid repetitions of similar explanations.

In FIG. 9, indicated at 61 is a rotary atomizing head type coating apparatus (hereinafter referred to simply as “a coating apparatus” for brevity) adopted as a second embodiment of the invention. Denoted at 62 is a main component valve assembly according to the second embodiment. This main component valve assembly 62 is built substantially in the same way as the main component valve assembly 21 in the foregoing first embodiment, except for the provision of a first switch valve 63 as described below.

Namely, indicated at 63 is a first switch valve incorporated into the main component valve assembly 62. For example, this first switch valve 63 is constituted by a 3-port 2-position directional control valve, and detachably mounted on outer peripheral side of a valve mount member 17 by a screw member 29 of a clamping mechanism 28, at a position on the outlet side of a check valve 32 and upstream of a junction point 41. Further, the first switch valve 63 is provided with an inlet port 63A which is connected to a check valve 32, a first outlet port 63B which is connected to a trigger valve 40, and a second outlet port 63C which is connected to a waste liquid tank 64. By a switching action of the first switch valve 63, an influent main component at the inlet port 63A is directed to the first outlet port 63B at the time of a paint coating operation to supply same to the trigger valve 40, and to the second outlet port 63C at the time of a washing operation to discharge same to the waste liquid tank 64 along with spent wash fluids.

Indicated at 65 is a hardener valve assembly according to the second embodiment of the invention. This hardener valve assembly 65 is built substantially in the same way as the hardener valve assembly 34 in the foregoing first embodiment, except for the provision of a second switch valve 66 as described below.

Namely, indicated at 66 is a second switch valve which is incorporated into the hardener valve assembly 65 of the second embodiment. This second switch valve 66 is also constituted by a 3-port 2-position directional control valve, and detachably mounted on outer peripheral side of the valve mount member 17 by the use of a screw member 29, at a position on the outlet side of a check valve 38 and upstream of a junction point 41. The second switch valve 66 is provided with an inlet port 66A which is connected to the check valve 38, a first outlet port 66B which is connected to the trigger valve 40, and a second outlet port 66C which is connected to the waste liquid tank 64. By a switching action of this second switch valve 66, an influent hardener at the inlet port 66A is directed to the first outlet port 66B at the time of a paint coating operation to supply same to the trigger valve 40, and to the second outlet port 66C at the time of a washing operation to discharge same toward the waste liquid tank 64 along with spent wash fluids.

Indicated at 67 is a third switch valve which is also detachably mounted on outer peripheral side of the valve mount member 17 by the use of a screw member 29. This third switch valve 67 is likewise constituted by a 3-port 2-position directional control valve, having an inlet port 67A which is connected to a third wash fluid selector valve 56, a first outlet port 67B which is connected to a wash fluid passage 12, and a second outlet port 67C which is connected to the trigger valve 40. By a switching action of the third switch valve 67, influent wash air and wash solvent at the inlet port 67A from wash air supply source 53Ar and wash solvent supply source 53Th of the wash fluid supply source 53 are directed to the first outlet port 67B to supply same to the rotary atomizing head 5 through a wash fluid passage 12 on the main coater body 2 and a wash fluid supply passage 7B in a feed tube 7, or to the second outlet port 67C to supply wash air and wash solvent to the trigger valve 40.

Instead of a 3-port 2-position directional control valve, each one of the first to third switch valves 63, 66 and 67 in the second embodiment may be constituted by a combination of a couple of 2-port 2-position directional control valves if desired.

Being arranged in the manner as described above, the coating apparatus 61 of the second embodiment is put in action for a paint coating operation, controlling various operating parts of the machine in predetermined timings as shown in a time chart of FIG. 10.

In the first place, upon completion of a paint coating operation with a previous color (e.g., with two component type paint containing a main component of color A mixed with a type a hardener), the machine is now put in actions for a color change (e.g., to another two component type paint containing a main component of color B mixed with a type b hardener) in the manner as follows.

In this washing stage, three different washing jobs, i.e., a job of washing off a main component, a job of washing off a hardener and a job of washing off a mixed paint containing both main component and hardener, are concurrently carried out independently of each other. Namely, for washing off residues of a main component of a previous color, the first switch valve 63 is changed over to a position on the side of the second outlet port 63C, followed by opening of the wash fluid valve 30 of the main component valve assembly 62 and opening of the first wash fluid selector valve 54. As a result, by wash air and wash solvent from the wash air supply source 53Ar and wash solvent supply source 53Th of the wash fluid supply source 53, the check valve 32 is pushed open and residues of color A in the common passage 31 are washed off, while spent wash fluids resulting from this washing operation are discharged toward the waste liquid tank 64 from the first switch valve 63. After washing off the main component of color A, the wash fluid valve 30 as well as the first wash fluid selector valve 54 is closed.

Simultaneously with the above color A wash-off operation, residues of a previous hardener are washed off by a hardener wash-off operation by switching the second switch valve 66 to a position on the side of the second outlet port 66C and opening the wash fluid valve 36 of the hardener valve assembly 65 and the second wash fluid selector valve 55. As a result, by wash air and wash solvent from the wash fluid supply source 53, the check valve 38 is pushed open and residues of the type a hardener in the common passage 37 are washed off, while spent wash fluids resulting from this washing operation are discharged toward the waste liquid tank 64 from the second switch valve 66. After washing off residues of the type a hardener, the wash fluid valve 36 as well as the second wash fluid selector valve 55 is closed.

Further, simultaneously with the above main component wash-off operation and the hardener wash-off operation, paint residues in paint passages downstream of the trigger valve 40 are washed off by changing over the third switch valve 67 to a position on the side of the second outlet port 67C and by opening the third wash fluid selector valve 56. As a result, wash air and wash solvent from the wash fluid supply source 53 are spurted toward the rotary atomizing head 5, letting the wash fluids flow through the trigger valve 40, paint passage 10, mixer mechanism 11 and paint supply passage 7A in the feed tube 7 from the third switch valve 67 to wash off paint residues in these portions. In a final stage of this washing operation, the third switch valve 67 is changed over to a position on the side of the first outlet port 67B, whereupon wash air and wash solvent from the wash fluid supply source 53 are spurted out from the wash fluid supply passage 7B of the feed tube 7 to wash off paint deposits on a fore distal end portions of the feed tube 7.

In this manner, in a washing stage, three different washing jobs are carried out concurrently and independently of each other, including the job washing off a main component, the job of washing off a hardener and the job of washing off a mixed paint containing both main component and hardener, permitting to shorten the washing time to a considerable degree.

As soon as a previous color has been washed off, the color changing operation proceeds to a next new color supply stage. In this stage, the first switch valve 63 is changed over to a position on the side of the first outlet port 63B, and the second switch valve 66 is changed over to a position on the side of the first outlet port 66B, filling the coating apparatus with a main component and a hardener of the next color in the same manner as in the next color supply stage of the first embodiment.

At the time of a paint coating operation with a two component type paint containing a main component of color B and a type b hardener in a mixed state, the first switch valve 63 is changed over to a position on the side of the first outlet port 63B while the second switch valve 66 is changed over to a position on the side of the first outlet port 66B, performing the paint coating operation in the same manner as in the coating stage of the foregoing first embodiment.

Thus, even the second embodiment, with the arrangements as described above, can produce substantially the same operational effects as the foregoing first embodiment. Especially in the case of the second embodiment, the paint supply system includes the first switch valve 63 which is switchable between a position for supplying a main component to the trigger valve 40 and a position for discharging spent wash fluids toward the waste liquid tank 64, the second switch valve 66 which is switchable between a position for supplying a hardener to the trigger valve 40 and a position for discharging spent wash fluids toward the waste liquid tank 64, and the third switch valve 67 which is switchable to supply wash air and wash solvent either to the rotary atomizing head 5 of the main coater body 2 or to the trigger valve 40.

Thus, in the washing stage, three different washing operations proceed concurrently to wash off a main component, a hardener and a mixed paint containing both main component and hardener, completing the respective washing operations on the coating apparatus in a shortened time period to guarantee high productivity.

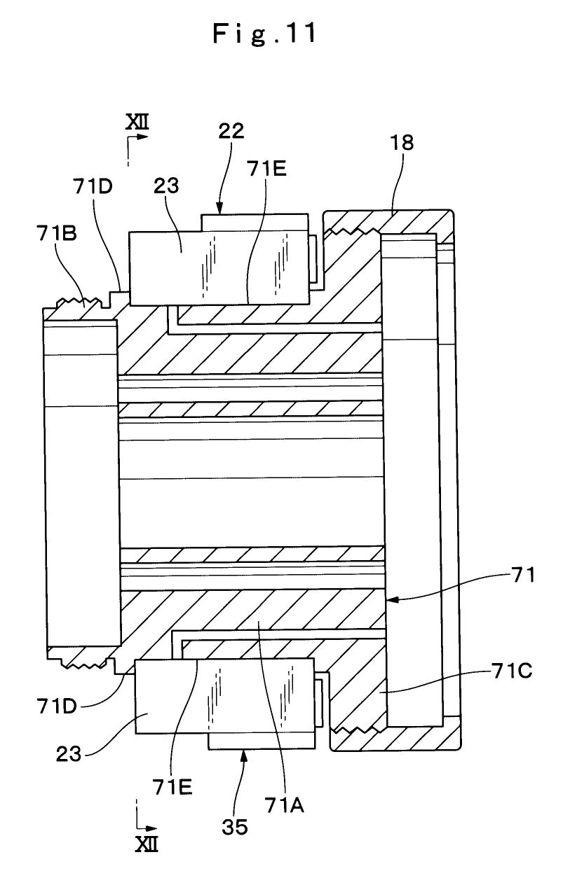

Now, turning to FIGS. 11 through 15, there is shown a third embodiment of the present invention.

This third embodiment has features in that a ball joint mechanism is employed as a valve retainer means, the ball joint mechanism being constituted by recessed coupling portions which are provided on the side of a valve casing, and valve retainers which are provided on the side of a valve mount member and biased into locking engagement with the recessed coupling portions by spring members. In the following description of the third embodiment, those component parts which are identical with the counterparts in the foregoing first embodiment are simply designated by the same reference numeral or character to avoid repetitions of similar explanations.

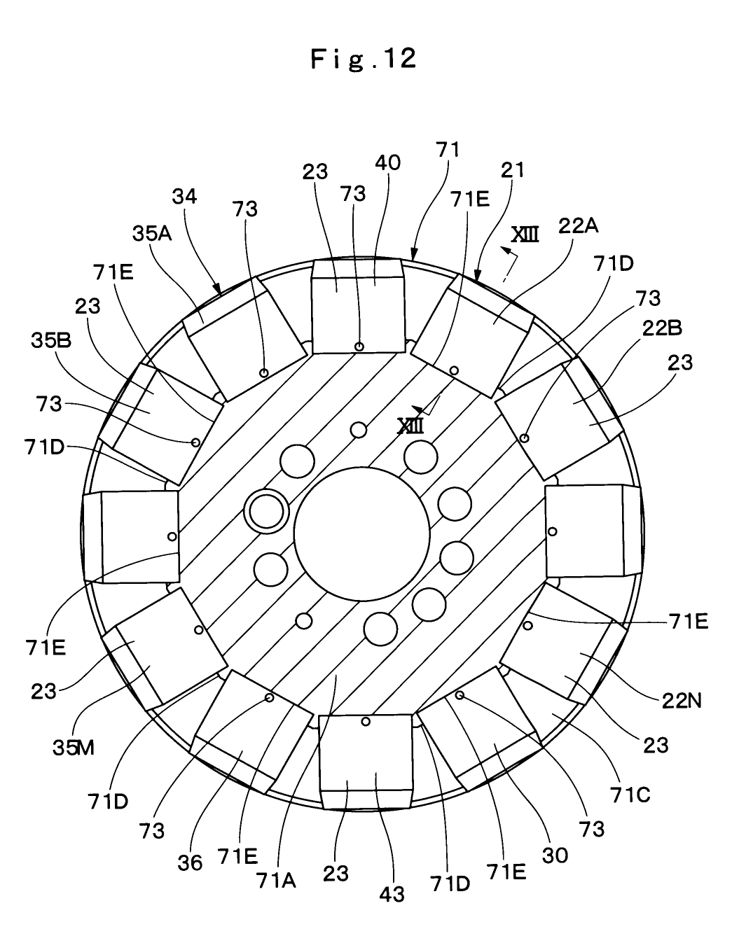

In FIG. 11, indicated at 71 is a valve mount member adopted in the third embodiment. Substantially in the same way as the valve mount member 17 of the first embodiment, this valve mount member 71 is arranged to mount respective main component valves 22 and wash fluid valve 30 of a main component valve assembly 21, respective hardener valves 35 and wash fluid valve 36 of a hardener valve assembly 34, trigger valve 40 and front end washing valve 43 around its outer periphery (see FIG. 12). Further, the valve mount member 71 is provided with a main body 71A, joint screw ring 71B, large diameter portion 71C and twelve mount surfaces 71D. Further, a valve fitting groove 71E is provided on each one of the mount surfaces 71D for fitting engagement with valves 22, 30, 35, 36, 40 and 43, the valve fitting groove 71E being provided with a couple of retainer receptacle holes 71F in opposite end walls, in corresponding positions relative to recessed coupling portions 73 which are provided on the side of a valve casing 23 as described hereinafter.

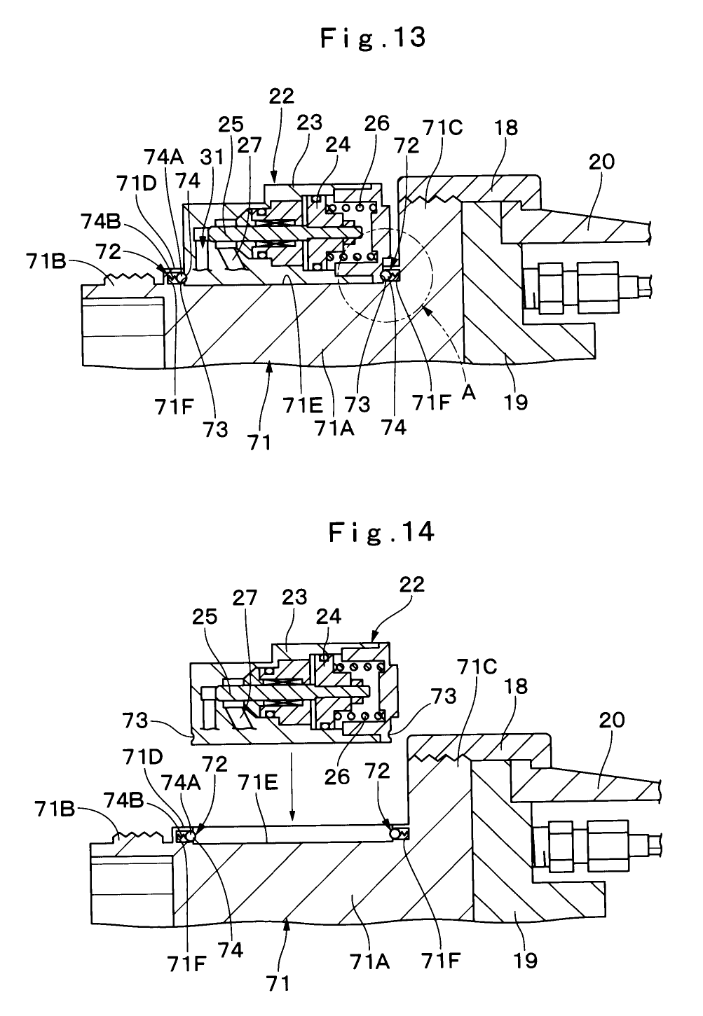

Indicated at 72 are a plural number of ball joint mechanisms which are provided on the outer peripheral side of the valve mount member 71, as another exemplary embodiment of valve retainer means. By these ball joint mechanisms 72, the respective main component valves 22 and wash fluid valve 30 of the main component valve assembly 21 as well as the respective hardener valves 35 and wash fluid valve 36 of the hardener valve assembly 34, trigger valve 40 and front end washing valve 43 are detachably mounted on the valve mount member 71. Further, as shown in FIGS. 13 and 14, the ball joint mechanisms 72 are each constituted by a recessed coupling portion 73 and a retainer 74 which will be described hereinafter.

Indicated at 73 are a couple of recessed coupling portions which are provided on a valve casing 23 of each one of the valves 22, 30, 35, 36, 40 and 43. These recessed coupling portions 73 are formed on opposite longitudinal end walls of the valve casing 23, at positions close to the valve mount member 71. The recessed coupling portions 73, which are to be engaged removably with a ball member 74A of a retainer 74, are formed in the shape of a concave recess, for example.

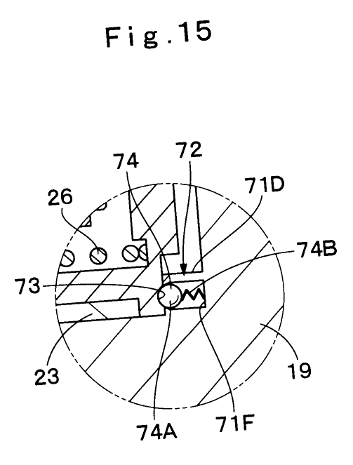

Indicated at 74 is a retainer which is accommodated in each one of the retainer receptacle holes 71F on the valve mount member 71. As shown in FIG. 15, each retainer 74 constitutes a ball joint mechanism 72 in cooperation with a recessed coupling portion 73. Each retainer 74 is constituted by a ball member 74A which is partly protrudable out of the retainer receptacle hole 71F, and a spring member 74B constantly biasing the ball member 74A in a protruding direction.

As a valve casing 23 is pushed into fitting engagement with a valve fitting groove 71E on the valve mount member 71, the ball member 74A of the retainer 74 is urged into locking engagement in one of recessed coupling portions 73 on the valve casing 23. As a result, a valve is releasably retained in position on the valve mount member 71 by the ball joint mechanisms 72 in a restrained state to prevent dislodgement of the valve. On the other hand, when a valve casing 23 is forcibly pulled in a dismantling direction, the ball members 74A are retracted against the actions of the spring members 74B of the retainers 74, releasing the valve casing 23 in a free state.

Thus, with the arrangements as described above, the third embodiment of the invention can produce substantially the same operational effects as the foregoing first embodiment. Especially in the case of the third embodiment, the ball joint mechanisms 72 are employed as valve retainer means for detachably holding the main component valves 22 and other valves on the valve mount member 71. The ball joint mechanisms 72 are each composed of the recessed coupling portion 73 provided on the part of a valve casing 23, and a retainer 74 provided on the part of the valve mount member 71 and having a ball member 74A to be engaged with the recessed coupling portion 73. Accordingly, a valve casing 23 can be mounted on or dismantled from the valve mount member 71 without using any tool or screw, and it becomes possible to carry out an assembling or replacing work more efficiently without possibilities of losing a machine part or parts.

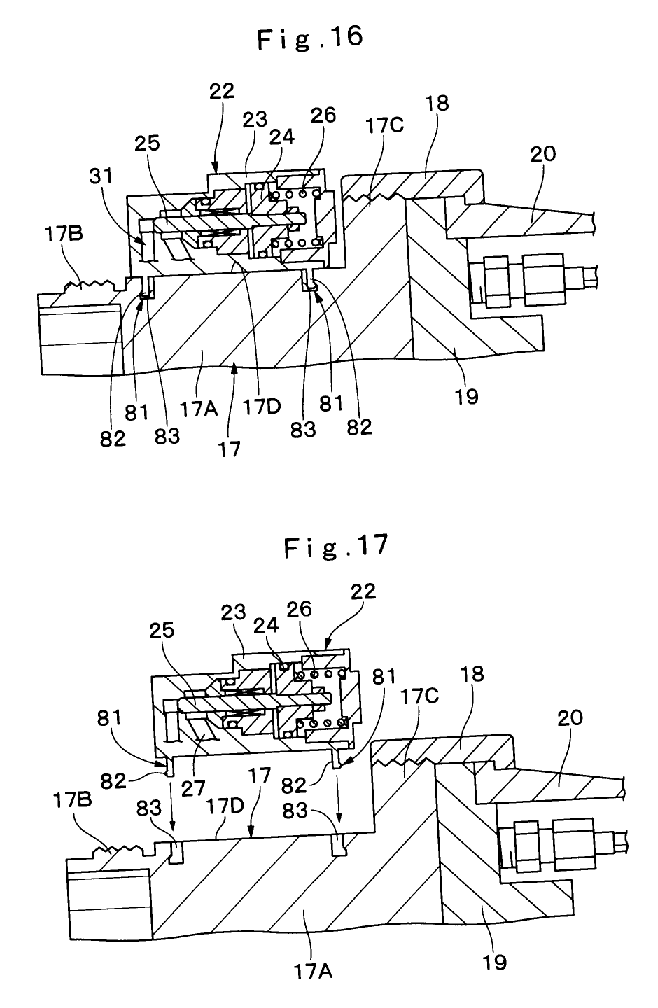

Now, turning to FIGS. 16 through 18, there is shown a fourth embodiment of the invention.

This embodiment has features in that valve retainer means is in the form of an interlocking pawl mechanism, including locking pawls which are provided on the part of a valve casing, and locking holes which are provided on the part of a valve mount member. In the following description of the fourth embodiment, those component parts which are identical with the counterparts in the foregoing first embodiment are simply designated by the same reference numeral or character to avoid repetitions of similar explanations.

In FIG. 16, indicated at 81 are a plural number of interlocking pawl mechanisms which are provided around the outer periphery of a valve mount member 17. By these interlocking pawl mechanisms 81, main component valves 22 and wash fluid valve 30 of a main component valve assembly 21 as well as hardener valves 35 and wash fluid valve 36 of a hardener valve assembly 34, trigger valve 40 and front end washing valve 43 are detachably mounted on a valve mount member 17. Each one of the interlocking pawl mechanisms 81 is composed of locking pawls 82 and locking holes 83 as described below.

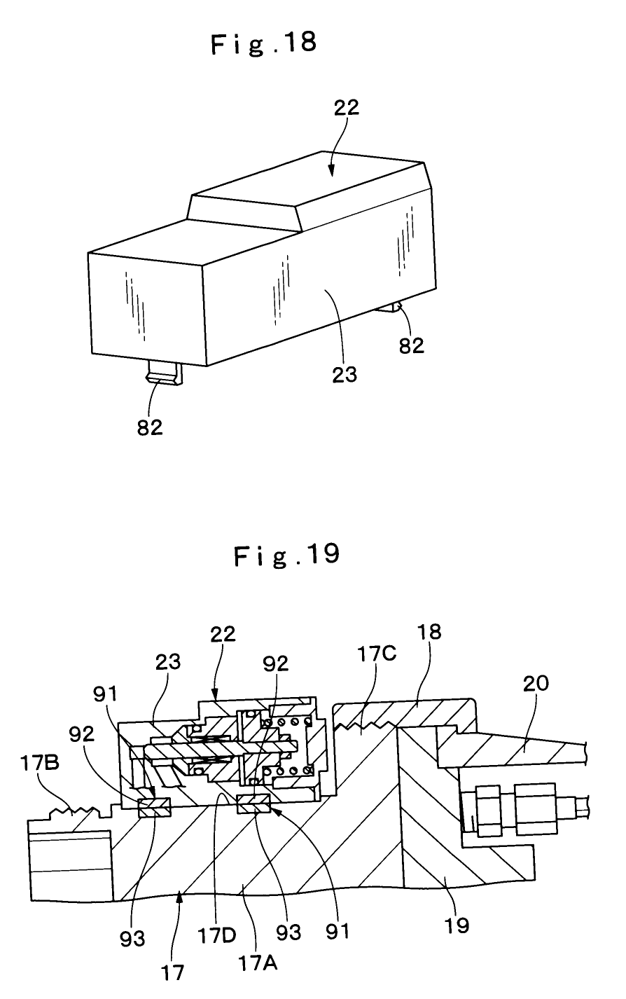

Denoted at 82 are a couple of locking pawls which are provided on a valve casing 23 of each one of valves 22, 30, 35, 36, 40 and 43. As shown in FIGS. 17 and 18, the locking pawls 82 are in the form of plate-like projections which are projected on the bottom side of a valve casing 23 and angularly bent in a direction away from each other at the distal end portions in an L-shape or in a reversed L-shape.

Indicated at 83 are a couple of locking holes which are provided in each one of mount surfaces 17D of the valve mount member 17. As shown in FIG. 17, these locking holes 83 are angularly bent in a direction away from each other at the respective bottom portions for interlocking engagement with the angularly bent portions of the locking pawls 82 in an L-shape or in a reversed L-shape.

The valve casing 23 can be detachably mounted on the valve mount member 17 by inserting the locking pawls 82 of the interlocking pawl mechanism 81 into the locking holes 83 until the angularly bent distal end portions of the locking pawls 82 are interlocked with the angularly bent bottom portions of the locking holes 83. On the other hand, when pulled forcibly in a direction away from the valve mount member 17, the respective locking pawls 82 are resiliently deformed to get out of interlocking engagement with the locking holes 83, releasing the valve casing 23 and allowing dismantling from the valve mount member 17.

Thus, with the arrangements as described above, the fourth embodiment can produce substantially the same operational effects as the foregoing third embodiment.

In the above-described first embodiment, the clamping mechanisms 28 are employed as valve retainer means, fixing the respective valves 22, 30, 35, 36, 40 and 43 by threading the screw members 29 into the screw holes 17E which are tapped on the side of the valve mount member 17 for the purpose of retaining the valve casing 23 on the valve mount member 17. However, the present invention is not limited to this particular example shown. For instance, as in a modification of FIG. 19, the valve casing 23 of each valve may be releasably fixed on a mount surface 17D of the valve mount member 17 by means of a magnetic mechanism 91, utilizing magnetic attraction between magnets 92 and 93 which are attached opposingly on the lower side of the valve casing 23 and the mount surface 17D of the valve mount member 17. This modification is also applicable to other embodiments of the invention.

Further, in the foregoing embodiments of the invention, by way of example the paint supply system is arranged to mix a main component of color A with a type a hardener and to mix a main component of color B with a type b hardener. However, the present invention is not limited to these particular examples shown. For instance, there may be a combination of a main component of color A and type b hardener, a combination of a main component of color B and type a hardener, or a combination of a main component of color A and type m hardener or a combination of a main component of color B and type m hardener.

Further, in the foregoing embodiments and in the drawings, by way of example the paint supply system is shown to have four main component valves 22 and four hardener valves 35. However, the present invention is not limited to this particular example shown. For instance, the paint supply system may have one, two, three or more than five main component valves 22 in combination with one, two, three or more than five hardener valves 35, may have main component valves 22 in a different number from hardener valves 35, for example, a larger number of main component valves 22 to supply a greater variety of main components as compared with the number of types of hardener.

Further, in the foregoing embodiments, by way of example the main coater body 2 is built as a bend type having an angularly bent front end on the housing 3. However, the present invention is not limited to the particular example shown. For instance, if desired, the main coater body 2 may built as a straight type coating apparatus having a straight housing.

Furthermore, in the foregoing embodiments, by way of example the main coater body 2 is provided with the rotary atomizing head 5 as a paint sprayer means. However, the present invention is not limited to this particular example. For instance, a pneumatic atomizing nozzle or a hydraulic atomizing nozzle may be provided on the main coater body 2 as a paint sprayer means if desired.

1. A coating apparatus comprised of:
a main coater body (2) having a paint sprayer means (5) at a front end thereof;
a main component valve assembly (21,62) composed of a main component valve (22) connected to a main component supply source (45), a wash fluid valve (30) connected to a wash fluid supply source (53), and a check valve (32) located on outlet side of said main component valve (22) and said wash fluid valve (30);
a hardener valve assembly (34,65) composed of a hardener valve (35) connected to a hardener supply source (49), a wash fluid valve (36) connected to a wash fluid supply source (53), and a check valve (38) located on outlet side of said hardener valve (35) and wash fluid valve (36); and
a trigger valve (40) located on outlet side of said check valve (32) of said main component valve assembly (21,62) and said check valve (38) of said hardener valve assembly (34,65) to turn on and off supply of a main component and a hardener to said paint sprayer means (5) of said main coater body (2);
characterized in that said coating apparatus comprises:
a valve mount member (17,71) provided at a rear end of said main coater body (2), and
a valve retainer means (28,72,81,91) adapted to detachably mount said main component valve (22) and wash fluid valve (30) of said main component valve assembly (21,62) along with said hardener valve (35) and wash fluid valve (36) of said hardener valve assembly (34,65) and said trigger valve (40) on said valve mount member (17,71).

2. A coating apparatus as defined in claim 1, wherein said valve mount member (17,71) is provided with two separate circumferential zones (A1,A2) around outer periphery thereof, and adapted to mount said main component valve (22) and wash fluid valve (30) of said main component valve assembly (21,62) in series in one circumferential zone (Al) and to mount said hardener valve (35) and wash fluid valve (36) of said hardener valve assembly (34,65) in series in the other circumferential zone (A2), and said trigger valve (40) is mounted on downstream side of said check valve (32) of said main component valve assembly (21,62) and said check valve (38) of said hardener valve assembly (34,65).

3. A coating apparatus as defined in claim 1, wherein said check valve (32) of said main component valve assembly (21,62) is mounted in association with either one of said main component valves (22) and said wash fluid valve (30) at a junction point (31A) thereof, while said check valve (38) of said hardener valve assembly (34,65) is mounted in association with either one of said hardener valves (35) and said wash fluid valve (36) at a junction point (37A) thereof.

4. A coating apparatus as defined in claim 1, further comprising a mixer means (11) detachably mounted on said main coater body (2) between said trigger valve (40) and said paint sprayer means (5) for mixing a main component and a hardener with each other.

5. A coating apparatus as defined in claim 4, wherein said main coater body (2) is provided with an openable transparent or semi-transparent cover (14) for covering said mixer means (11).

6. A coating apparatus as defined in claim 1, further comprising a front end washing valve (43) connected to said wash fluid supply source (53) to turn on and off a supply of a wash fluid to said paint sprayer means (5) of said main coater body (2), said front end washing valve (43) being detachably mounted on said valve mount member (17,71) by means of a valve retainer means (28,72, 81,91).

7. A coating apparatus as defined in claim 1, further comprising a first switch valve (63) located on outlet side of said check valve (32) of said main component valve assembly (62), said first switch valve being switchable between a first position for supplying a main component to said trigger valve (40) and a second position for discharging spent wash fluids to a waste liquid tank (64), a second switch valve (66) located on outlet side of said check valve (38) of said hardener valve assembly (65), said second switch valve being switchable between a first position for supplying a hardener to said trigger valve (40) and a second position for discharging spent wash fluids to said waste liquid tank (64), and a third switch valve (67) adapted to switch a supply of wash fluids from said wash fluid supply source (53) either to said paint sprayer means (5) of said main coater body (2) or to said trigger valve (40),
each one of said first switch valve (63), second switch valve (66) and third switch valve (67) being detachably mounted on said valve mount member (17,71) by means of a valve retainer means (28, 72,81,91).

8. A coating apparatus as defined in claim 1, wherein said valve retainer means is in the form of a clamping mechanism (28) adapted to clamp a screw member (29) into a screw hole (17E), in the form of a ball joint mechanism (72) adapted to engage a retainer ball (74A) with a recessed coupling portion (73), in the form of an interlocking pawl mechanism (81) adapted to lock locking pawls (82) into locking holes (83), or in the form of a magnetic mechanism (91) adapted to retain a valve in position by the use of magnets (92,93).
